(19) United States
(12) Patent Application Publication
(10) Pub. No.: US 2026/0214615 A1
(43) Pub. Date: Jul. 23, 2026

(54) SPATIAL DIVERSITY MEASUREMENT, TRACKING AND MANAGEMENT

(71) Applicant: Cohere Technologies, Inc., San Jose, CA (US)

(72) Inventor: Shlomo Selim RAKIB, San Jose, CA (US)

(21) Appl. No.: 18/865,509

(22) PCT Filed: May 17, 2023
(86) PCT No.: PCT/US2023/022519

§ 371 Date: Nov. 13, 2024

Related U.S. Application Data
(60) Provisional application No. 63/364,869, filed on May 17, 2022.

(51) Int. Cl. H04W 64/00

(52) U.S. Cl. CPC H04W 64/00

(57) ABSTRACT

Methods, systems and devices for wireless communication are described. One example method includes performing, by a network device, gain, phase and timing imbalance calibrations of multiple wireless devices in a wireless network, estimating, by the network device, angles of arrivals of the multiple wireless devices, determining wireless device grouping based on geometric properties including angels of arrivals of the multiple wireless devices, scheduling data collection from the multiple wireless devices based on the geometric properties, and simultaneously scheduling groups of wireless devices from the multiple wireless devices for data transmission or reception based on the grouping.

### CROSS-REFERENCE TO RELATED APPLICATION

This application claims priority to U.S. Provisional Patent Application No. 63/364,869, filed on May 17, 2022, the disclosure of which is hereby incorporated by reference herein in its entirety.

### TECHNICAL FIELD

The present document relates to wireless communication.

### BACKGROUND

Due to an explosive growth in the number of wireless user devices and the amount of wireless data that these devices can generate or consume, current wireless communication networks are fast running out of bandwidth to accommodate such a high growth in data traffic and provide high quality of service to users.

Various efforts are underway in the telecommunication industry to come up with next generation of wireless technologies that can keep up with the demand on performance of wireless devices and networks. Many of those activities involve situations in which a large number of user devices may be served by a network.

### SUMMARY

This document discloses techniques that may be used by wireless networks to achieve several operational improvements.

In one example aspect, a wireless communication method is disclosed. The method includes performing, by a network device, gain, phase and timing imbalance calibrations of multiple wireless devices in a wireless network, estimating, by the network device, angles of arrivals of the multiple wireless devices, determining wireless device grouping based on geometric properties including angels of arrivals of the multiple wireless devices, scheduling data collection from the multiple wireless devices based on the geometric properties, and simultaneously scheduling groups of wireless devices from the multiple wireless devices for data transmission or reception based on the grouping.

In another example aspect, another wireless communication method is disclosed. The method includes determining, by a first network device, a geometric property of a wireless device; communicating, by the first network device, the geometric property of the wireless device to a second network device selected based on the geometric property; and providing wireless connectivity to the wireless device in coordination with the second network device.

In another example aspect, a wireless communication apparatus that implements the above-described method is disclosed.

In yet another example aspect, a wireless system in which one or more of the above-described method are implemented is disclosed.

In yet another example aspect, the method may be embodied as processor-executable code and may be stored on a computer-readable program medium.

In yet another aspect, a wireless communication system that operates by providing a single pilot tone for channel estimation is disclosed.

These, and other, features are described in this document.

### BRIEF DESCRIPTION OF THE DRAWINGS

Drawings described herein are used to provide a further understanding and constitute a part of this application. Example embodiments and illustrations thereof are used to explain the technology rather than limiting its scope.

FIG. 1 shows an example communication network.

FIG. 2 shows a simplified example of a wireless communication system in which uplink and downlink transmissions are performed.

FIG. 3 is a pictorial description of various options for calibration of a receiver.

FIG. 4 is a block diagram of an example implementation of an integrated radio unit (RU) and a distributed unit (DU) in a wireless network.

FIG. 5 is a block diagram of an example embodiment in which radio and antenna are separately shown.

FIGS. 6A and 6B are flowcharts of example wireless communication methods.

FIG. 7 is a block diagram showing example functional blocks of a multi-user multi-input multi-output (MU-MIMO) implementation.

FIG. 8 depicts an example circuit for antenna calibration.

FIG. 9 depicts an example implementation in which an external calibration box is used for external antennas.

FIG. 10 shows an example implementation of antenna calibration port.

FIG. 11 depicts examples of antenna gain or phase misalignment.

FIG. 12 depicts an example implementation of determination of antenna gain and phase misalignment.

FIG. 13 shows an example configuration of three wireless cells in which receiver localization and calibration is performed.

FIG. 14 shows an example implementation of a trilateration process.

FIG. 15 shows an example implementation of receiver triangularization in a wireless network.

FIG. 16 shows an example implementation of receiver localization.

FIG. 17 shows an example of pose or orientation estimation of a user equipment (UE).

FIG. 18 shows an example of a wireless network that is spread across a wide geographic region.

FIG. 19 shows an example of triangularization of receivers in a wireless communication cell.

FIG. 20 shows another example of triangularization.

FIG. 21 shows an example of an implementation of passive tracking.

FIG. 22 shows a listing of various transmissions performed in a wireless network.

FIG. 23 shows example stack implementing wireless data communication.

FIG. 24 shows another example stack implementing wireless data communication.

FIG. 25 shows an example of architecture of a cooperative multipoint (COMP) network operation.

FIG. 26 shows an example implementation of a MIMO DU.

FIG. 27 pictorially depicts an example of time, frequency and space multiplexing of data traffic for multiple users.

FIG. 28 pictorially depicts an example implementation of spatial filtering in wireless communication.

FIGS. 29-32 show examples of fractional beam scheduling scenarios.

FIG. 33 shows an example of a wireless system including a base station with L antennas and multiple users.

FIG. 34 shows an example of a subframe structure that can be used to compute second-order statistics for training.

FIG. 35 shows an example of prediction training for channel estimation.

FIG. 36 shows an example of prediction for channel estimation.

FIG. 37 is an example of a transmitter and receiver.

FIGS. 38A, 38B and 38C show examples of different bandwidth partitions.

FIG. 39 shows an example of a bandwidth partition with the same time interval.

FIG. 40 shows an example of a bandwidth partition with a different time interval.

FIG. 41 shows an example of channel prediction over the same time interval.

FIG. 42 shows an example of channel prediction over a different time interval.

FIG. 43 shows an example of a hardware platform.

FIGS. 44 to 46 are flowcharts for various example methods of wireless communication.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Certain standard-specific terms are used for illustrative purpose only, and the disclosed techniques are applicable to any wireless communication systems.

In wireless communication, to achieve greater throughput in wireless communication, transmission beams may be used to limit the radiated bandwidth along a certain direction between a transmitter device and an intended receiver of that transmission. A transmitter may be configured to provide wireless transmissions to multiple receiver devices, such as a base station in a wireless network. A pre-coding technique may be applied to achieve the beamforming. The pre-coding often tends to be geometric in nature and attempts to steer the beam in a particular direction while adding nulls in certain other directions. To be able to achieve effective pre-coding it is useful to have the antenna accurately calibrated.

However, in practical wireless systems, presently there are no techniques available to systematically measure antenna directions and no reference signals are used for calibration or measurement of antenna angular or gain distortion. The bias due to angular misalignment might enter computations of gain, phase and channel measurements. In wireless systems, a given wireless device (e.g., user equipment UE or a handset) is often within signal transmission range of multiple network devices (e.g., base stations, transmission towers, or transmission-reception points TRPs). Current wireless networks have begun some form or cooperative transmission/reception among various network devices to enable communication with wireless devices in coverage area but lack a coordinated effort to measure precise UE positions and map the geographic region covered by the multiple base stations for providing a denser transmission/reception grid that enables increasing number of bits per hertz per second that can be communicated within a geographic area.

The techniques described in the present document may be used by various embodiments to address the above-discussed shortcomings of present-day wireless networks, and others. For examples, base stations may perform measurements of angular positioning of antennas, localization of receivers that helps with the angular positioning of antenna and using this information to provide additional improvements to the operation of a wireless network including, e.g., more throughput, better scheduling of data traffic and other advantages described throughout the present document. In one advantageous aspect, these operational improvements may be achieved without a need to introduce additional reference signal transmissions into an existing wireless transmission protocol implemented by a wireless network. For example, a 4G deployment may be able to use existing 4G reference signals to accomplish angle of arrival measurements and wireless device grouping, as further described in the present document. In a similar manner, a 5G New Radio (NR) deployment may be able to use 5G reference signal and data transmissions to perform gain/phase/timing imbalance calculations across multiple antennas and be able to provide input to wireless device grouping for subsequence transmission/reception of downlink/uplink signals. These, and other, features are described in the present document.

### 1 Examples of Wireless Systems

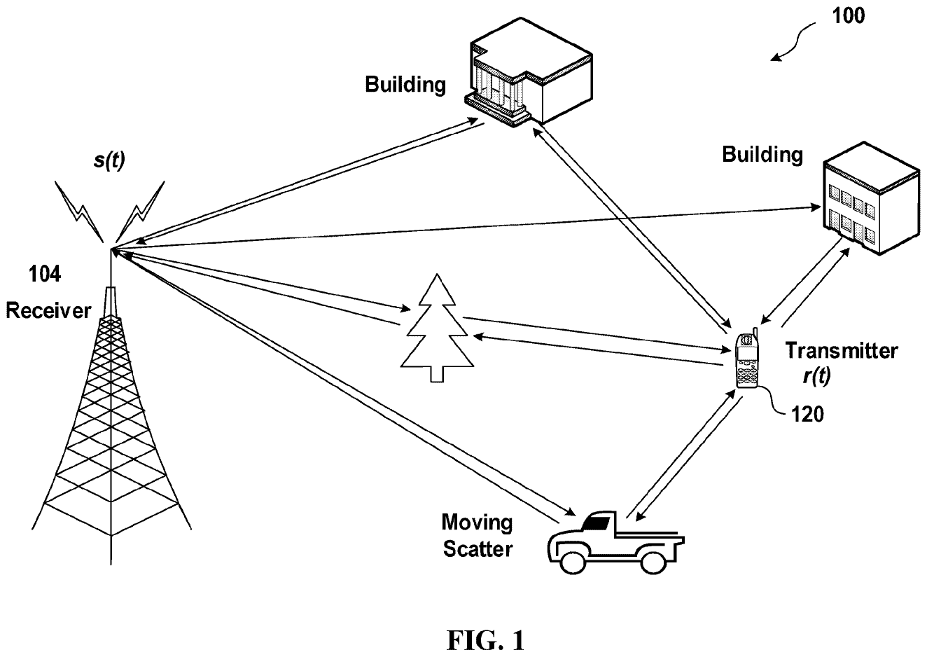

FIG. 1 shows an example of a wireless communication system 100 in which a transmitter device 102 transmits signals to a receiver 104. The signals may undergo various wireless channels and multipaths, as depicted. Some reflectors such as buildings and trees may be static, while others such as cars, may be moving scatterers. The transmitter device 102 may be, for example, a user device, a mobile phone, a tablet, a computer, or another Internet of Things (IoT) device such as a smartwatch, a camera, and so on. The receiver device 104 may be a network device such as the base station. The signals transmitted from the base station to the transmitter 102 may experience similar channel degradations produced by static or moving scatterers. The techniques described in the present document may be implemented by the devices in the wireless communication system 100. The terms “transmitter” and “receiver” are simply used for convenience of explanation. As further described herein, depending on the direction of transmission (uplink or downlink), the network station may be transmitting or receiving and correspondingly user device may be receiving or transmitting.

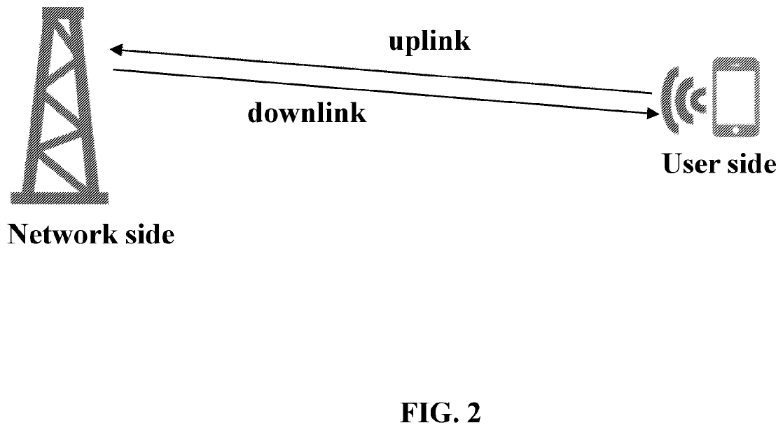

FIG. 2 shows a simplified wireless network to highlight certain aspects of the disclosed technology. A transmitter transmits wireless signals to a receiver in the wireless network. Some transmissions in the network, variously called as downlink or downstream transmissions, a network-side node such as a base station acts as a transmitter of wireless signals and one or more user devices act as the receiver of these wireless signals. For some other transmissions, as depicted in FIG. 2, the direction of transmission may be reversed. Such transmissions are often called uplink or upstream transmissions. For such transmissions, one or more user devices act as transmitters of the wireless signals and a network-side node such as the base station acts as the receiver of these signals (as depicted in FIG. 2). Other type of transmissions in the network may include device-to-device transmissions, sometimes called direct or sideband transmissions. While the present document primarily uses the terms “downlink” and “uplink” for the sake of convenience, similar techniques may also be used for other situations in which transmissions in two directions are performed—e.g., inbound or incoming transmissions that are received by a wireless device and outbound or outgoing transmissions that are transmitted by a wireless device. For example, downlink transmissions may be inbound transmissions for a user device, while outbound transmissions for a network device. Similarly, uplink transmission may be inbound transmissions for a network device while outbound transmissions from a wireless device. Therefore, for some embodiments, the disclosed techniques may also be described using terms such as “inbound” and “outbound” transmission without importing any 3GPP-specific or other wireless protocol-specific meaning to the terms “uplink” and “downlink.”

In frequency division multiplexing (FDM) networks, the transmissions to a base station and the transmissions from the base station may occupy different frequency bands (each of which may occupy continuous or discontinuous spectrum). In time division multiplexing (TDM) networks, the transmissions to a base station and the transmissions from the base station occupy a same frequency band but are separated in time domain using a TDM mechanism such as time slot-based transmissions. Other types of multiplexing are also possible (e.g., code division multiplexing, orthogonal time frequency space (OTFS) multiplexing, spatial multiplexing, etc.). In general, the various multiplexing schemes can be combined with each other. For example, in spatially multiplexed systems, transmissions to and from two different user devices may be isolated from each other using directional or orientational difference between the two end points (e.g., the user devices and a network station such as a base station).

### 2 Examples of UE and Base Station (BS) Implementations

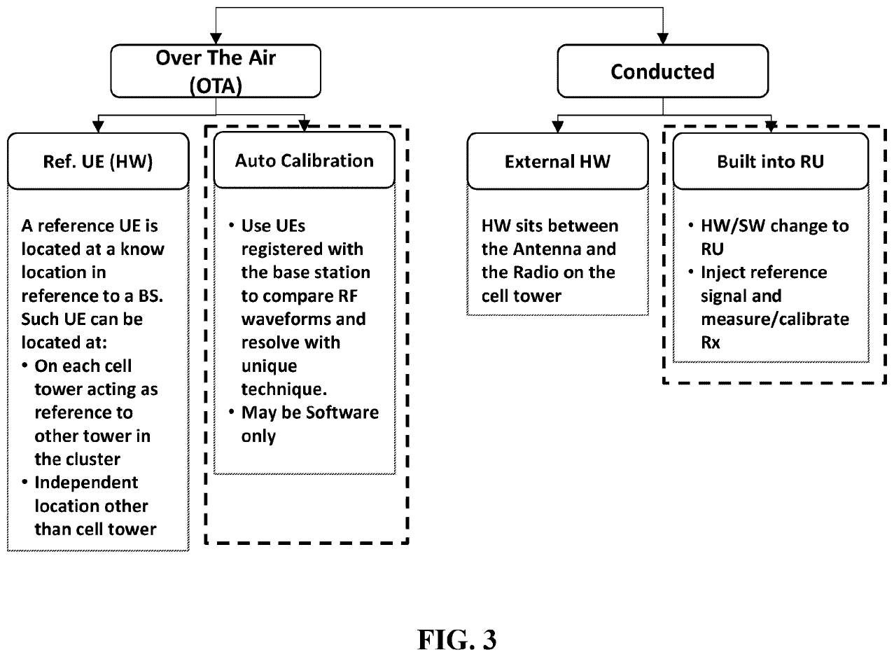

With reference to FIGS. 3-5 some examples of UE and base station implementations in which the various techniques described in the present document may be implemented are discussed. In particular, with respect to the network-side, an example framework in which a distributed unit DU may be used for scheduling is described.

FIG. 3 is a pictorial description of various options for calibration of a receiver. To be effectively able to us a zero-forcing technique for user multiplexing in a wireless system, it is advantageous to calibrate the transmit side (Tx) so that the zero-forcing effectively works by minimizing unwanted signal leakage to other receivers. However, in addition to calibration of the Tx side, it may also be useful to calibrate the receive side (Rx) for forming beams that maximize inband transmission while minimizing out-of-band signal energy. As shown in FIG. 3, Rx calibration may be performed using two approaches. In the over the air (OTA) approach, shown on left side of the drawing, in a first method, reference UE hardware may be used. The reference UE may be placed at a known location in reference to a base station. The location may be, e.g., each cell tower in order to measure transmissions from other neighboring cell towers, or another location in a wireless cell. Using a second method, auto-calibration may be performed using UEs registered with a base station to compare RF waveforms and resolve geometric properties such as UE location. Such an implementation may be deployed as a software-only solution.

As shown on the right-hand side of FIG. 3, the calibration may be performed in a conducted manner as follows. In some embodiments, external hardware may be positioned between antenna and radio portion of a cell tower to perform the calibration. In some embodiments, the calibration function may be built into the radio unit (RU). For example, a reference signal may be injected in the received transmissions for measuring and calibrating the Rx. If equipped with this capability, and when needed, the integrated RU should initiate a self-calibration of the relative phase, gain and delay between transmit antenna ports.

To create sufficiently accurate beam patterns with a uniform linear array antenna, the calibrated radio may meet the following specifications between transmit antenna ports:
Maximum phase variation: 2 degrees
Maximum gain variation: 0.25 dB
Maximum delay variation: 0.15 ns

A delay of 0.15 ns assuming a propagation velocity of 0.7 c (c is speed of light) corresponds to 3.2 cm, so it is feasible that this degree of delay matching can be met by such an implementation or a one-time calibration in manufacturing.

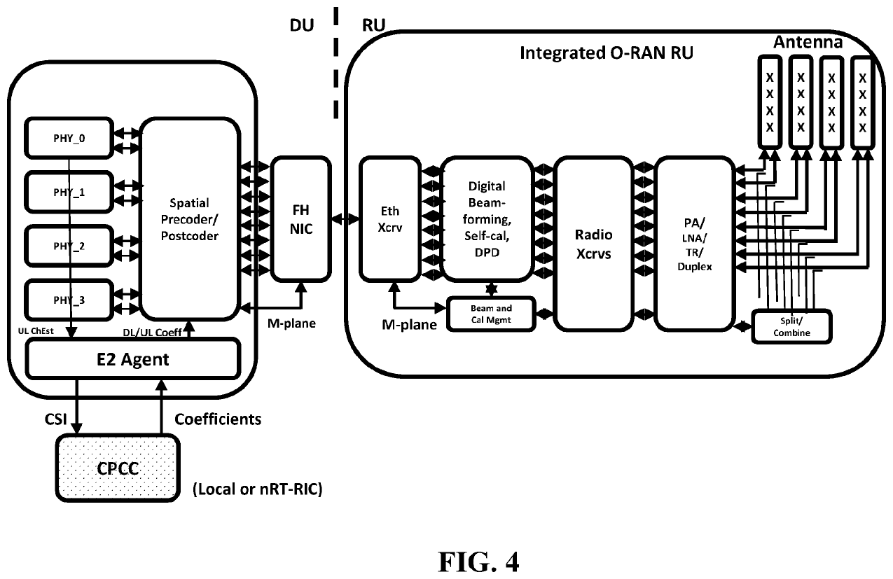

FIG. 4 is a block diagram of interfacing between an example implementation of an integrated radio unit (RU) and a distributed unit (DU) in a wireless network. Various functions on the left correspond to distributed unit (DU) functionality and functions shown on the right corresponds to functions performed by a radio unit (RU).

DU functions include multiple PHY layer protocol stack implementations, a spatial precoder or postcoder and an E2 agent. The E2 agent may interface with the CPCC function (channel prediction, channel calibration) to communicate channel state information (CSI) to the CPCC and receive coefficient estimates for the channel. The E2 agent may receive uplink channel estimates from the PHY implementations and may provide the downlink or uplink coefficients to the spatial precoder/postcoder. The precoding/postcoding function communications with the network interface such as a backbone fiber interface to radio units (RU). The RU may include network interfaces (e.g., ethernet transceivers) that receive and send data. A digital beamforming and/or self-calibration module may be coupled with radio transceivers that are in turn coupled with multiple antennas through a splitter/combiner. The CPCC function may be locally implemented at the DU or may be implemented in a distributed matter using cloud computing resources.

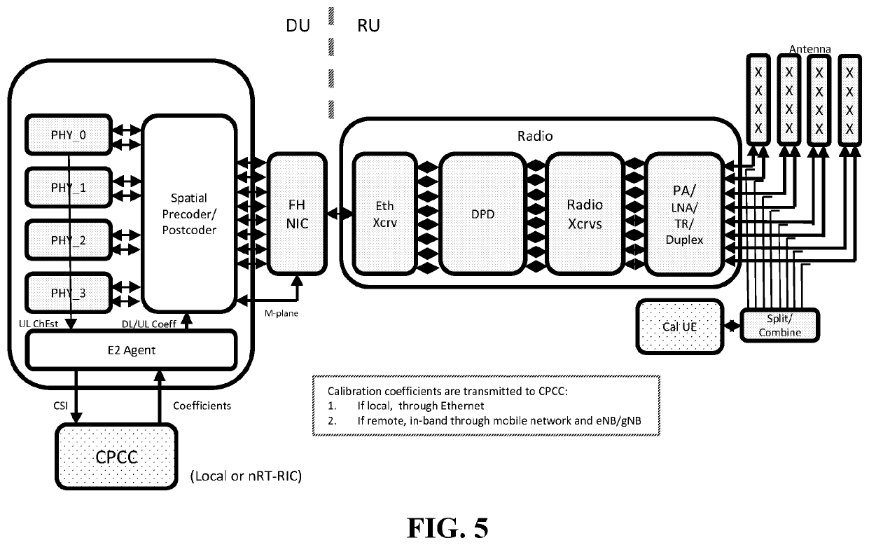

FIG. 5 is a block diagram of an example embodiment in which radio and antenna are separately shown. In comparison with the implementation in FIG. 4, the block diagram shown in FIG. 5 may have separate radio and antenna implementations. In this configuration, calibration coefficients may be transmitted to the CPCC through a local ethernet connection, or through an in-band communication path in the wireless network. As further shown in FIG. 5, a new function, called Cal UE (UE calibration) function may be used (e.g., representing a reference UE) to calibrate signal transmission path of the RU and DU through which signals from other UEs will also travel.

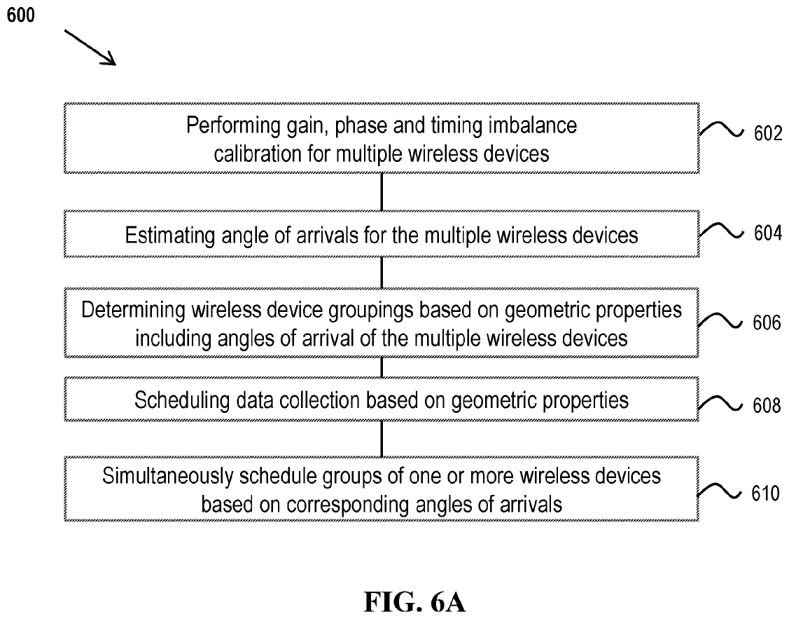

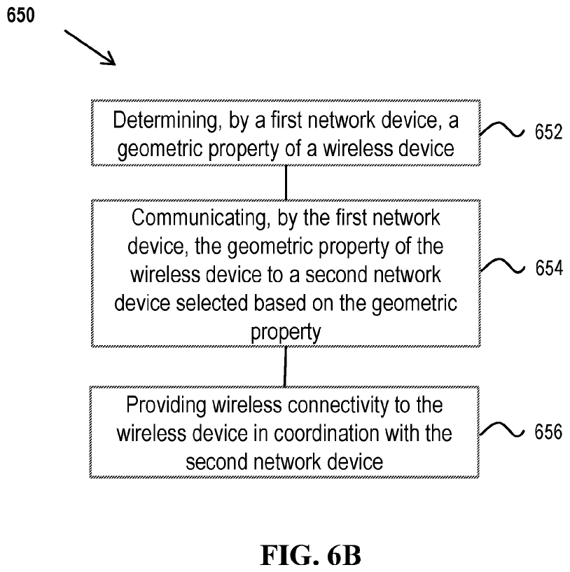

FIG. 6A shows an example of a flowchart of wireless communication method 600.

At 602, gain, phase and timing imbalance calibration for multiple wireless devices is estimated. For example, techniques described in the present section may be used for the calibration operation. In some embodiments, the antenna calibration techniques described in Section 3 of the present document may be used.

At 604, angle of arrivals for multiple wireless devices are measured. For each device, its corresponding angle of arrival may be measured by measuring a difference between signals received at different antenna ports of the base station and estimating the angle of arrival based on gain, phase, timing imbalance of the signals received at different antennas and the geometric separation of the antennas. In some embodiments, advantageously, signals used for the various calibrations may be used for the estimation of angle of arrival. For example SRS transmissions from mobile devices may be used for measuring angles of arrival.

At 606, wireless device pairing is determined based on geometric properties such as angles of arrival of multiple wireless devices. Various examples of geometric properties are disclosed throughout the present document, including for example in Section 4, which describes location, pose of the wireless device as geometric properties. The geometric properties may be based on an absolute coordinate system (e.g., a reference frame such as global positioning system or a world coordinate system) or a relative coordinate system (e. g., distance and angular separation from a reference point of the network such as the base station being assumed to be at (0, 0) location).

At 608, data collection is scheduled for the multiple wireless devices based of the geometric properties. As disclosed in the present document, data collection may include receiving measurement reports from the wireless devices. The collected data may be used for storage into a database to calibrate a topical geographical map of the area of coverage of the base station. The collected data may also include movement related information for the wireless devices. For example, a trajectory of a wireless device may be predicted based on the collected data (e.g., delay and Doppler characteristics of a channel between the base station and the wireless device) to predict a next location of the wireless device. The predicted next location may be used for grouping, as further disclosed in the present document. Some additional examples are disclosed in Sections 5 and 6. In some embodiments, grouping users in different groups is based on localization and scheduled together into a layer or a beam for transmission and reception, as described in Section 12.

At 610 data transmissions to or from the wireless devices are scheduled such that transmissions for wireless devices having a pre-determined angle of separation may be performed simultaneously, using same time and/or frequency domain resources. It is noted that, in a given time slot, only devices that need to send or receive data are grouped and scheduled according to their relative angles of separation. For example, in some embodiments, 20 degree angle of separation with respect to the base station may be assumed to be sufficient for the base station to transmit or receive signals from two UEs, without any significant amount of interference between them. The interference may be measured in terms of a bit or block error rate. In some embodiments, for the simultaneous scheduling, only the wireless devices that currently are in need of data reception or data transmission may be considered for the grouping for simultaneous scheduling.

In some embodiments, the method 600 further includes storing, in a database, historical data about previous angles of arrival measurements and groupings in the wireless network. This information may be used for future planning and operation of the wireless network. Some example embodiments are disclosed in Sections 10 and 11.

In some embodiments, the gain, phase and timing imbalance calibrations are performed using transmissions comprising random access transmissions, reference signal transmissions or data transmissions.

In some embodiments, the gain, phase and timing imbalance calibrations are performed using the angles of arrival of the multiple wireless devices.

In some embodiments, the determining wireless device grouping comprises determining the grouping according to a rule that depends on differences in angles of arrival of wireless devices such that two devices having angles of arrivals less than a pre-determined thresholds are precluded from inclusion in a same group.

In some embodiments, the estimating the angles of arrivals comprises estimating an angle of arrival of a particular wireless device based on a combination of one or more of (a) a feedback signal received from the particular wireless device in response to a transmission to the particular wireless device, (b) a reference signal transmission received from the particular wireless device, or (3) location estimates for the particular wireless device received from neighboring network devices.

In some embodiments, the geometric properties include one or more of absolute locations of the multiple wireless devices, relative locations of the multiple wireless devices, or antenna orientations of the multiple wireless devices.

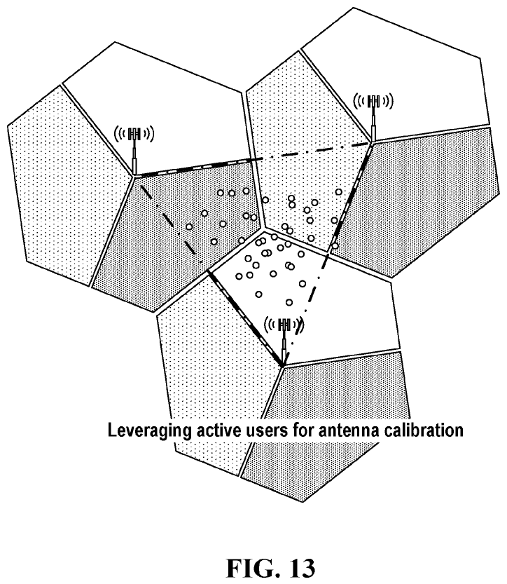

Another method of wireless communication (e.g., method 650 depicted in FIG. 6B) includes determining (652), by a first network device, a geometric property of a wireless device; communicating (654), by the first network device, the geometric property of the wireless device to a second network device selected based on the geometric property; and providing (656) wireless connectivity to the wireless device in coordination with the second network device. The method may be implemented by a base station, e.g., as described with reference to FIGS. 13-16, 18-21 in the present document.

In some embodiments, the geometric property comprises one or more of an absolute location of the wireless device, a relative location of the wireless device or orientation of multiple antennas of the wireless device. Various geometric properties and determination thereof are described throughout the present document.

In some embodiments, the relative location of the wireless device comprises an angle or arrival between the first network device and the wireless device.

In some embodiments, the communicative is performed responsive to a query from the second network device. For example, a wireless device may be in a coverage area of the second network device. In the process of localization and grouping of the wireless device, the second network device may query the first network device such that the second network device is able to perform triangularization to obtain a precise location of the wireless device.

In some embodiments, the providing wireless connectivity comprises scheduling transmissions to and from the wireless device, e.g., providing wireless coverage to the wireless device.

In some embodiments, the providing wireless connectivity comprises coordinating with the second network device that schedules transmissions to and from the wireless device.

In some embodiments, the second network device is selected along an angular direction towards that of the wireless device as determined by the geometric property. For example, the first network device may split the 360-degree region around it into virtual sectors (e.g., 60 degree hexagonal/triangular sectors, or 90 degree rectangular sectors, etc.). Next, the first network device may determine a virtual sector within which a particular wireless device falls in. Based on this, the first network device may select the second network device to be each device that is at a vertex of the virtual sector in which the particular wireless device is estimated to be located.

Further aspects and implementations of methods 600 and 650 are described throughout the present document.

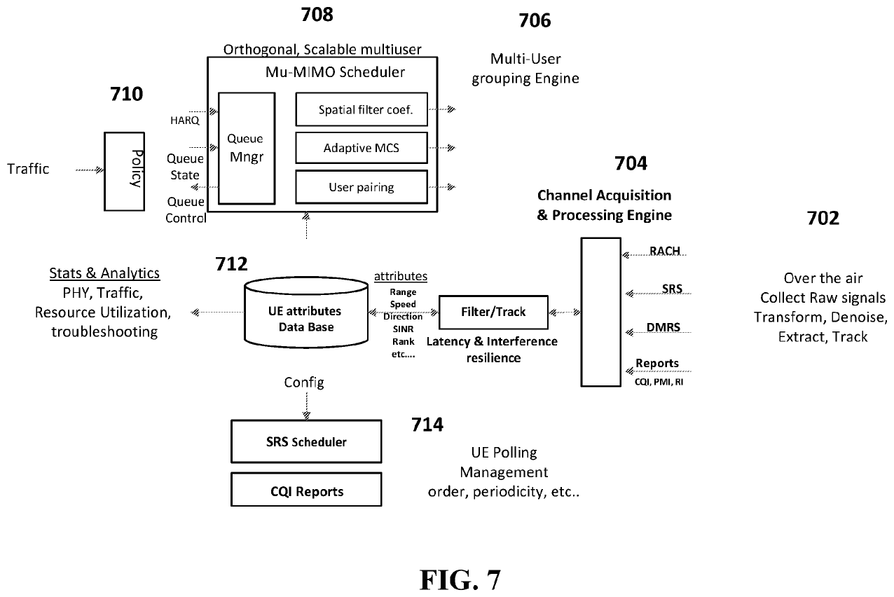

FIG. 7 is a block diagram showing example functional blocks of a multi-user multi-input multi-output (MU-MIMO) implementation. At 702, various over the air signals are collected and processed. The processing includes transformation (or inverse transformation) of signals from one domain into another domain (e.g., delay-Doppler to time frequency domain or from frequency domain to time domain). The transformed signaled may be denoised by averaging or other noise filtering techniques, signals may be extracted. Finally, signal beams may be tracked based on the extracted signals. As depicted in 704, examples of these signals include traditional reference signals such as demodulation reference signal (DMRS), sounding reference signal (SRS), transmissions on random access channel (RACH). Other received signals may include various system reports such as channel quality indicator (CQI) information, pre-coding matrix indicator (PMI), resource indicator (RI), and so on. This information may be used by a channel acquisition and processing engine that estimates the channel between the receiver that performs the estimation and transmitter of the OTA signals. Each UE that sends this information may be tracked individually for its position and channel quality to generate information about how much latency or interference is being experienced by the UE. At the same time, such measurements may also be associated with the UE at that time, but also with the position of the UE.

Put differently, UE measurements over a period of time may be used to generate UE-specific measurements and position-specific measurements. For example, over a period of time, a given geographical location may be occupied by several UEs at different times. Accordingly, a network-side computing device may collect channel quality information from multiple UEs, and extract the commonality to associate this with the particular geographic location. By doing so, over a period of time, the network may become aware of a topology heat map (or feature map) of the channel at all geographical locations within the coverage area.

With respect to the UE-specific parameters being collected, the network may use attributes such as the UE's range, speed, direction, reported signal to interference and noise ratio (SINR), rank, and so on. This information may be added to a UE attributes database, as shown at 712. This information, along with the position-specific attributes may be used to perform various network side calculations related to statistics and analysis for improving use of physical layer resources, managing data traffic, resource utilization and also for trouble shooting. For example, the network heat map may make the network aware of certain geographic locations that have a blind spot with respect to some or all base stations. In such cases, transmissions or receptions may be configured to avoid such blind spots by using non-blind resources such as frequencies or beam directions.

Further referring to FIG. 7, the network may also implement a control function, as shown in 714, for managing the whole process of polling UEs for information, periodicity of report generation, scheduling of reference signals and CQI reports, and so on.

The information from the UE attributes database may also be used for grouping and scheduling of UEs. An MU-MIMO scheduler 708 may use UE-specific and position-specific information and use this information to provide a platform for generating orthogonal, multi-user schedules using techniques, including—deciding coefficients of spatial filters used for transmitting or receiving multi-user beams, a modulation and coding scheme decision function that is adaptive to the changing nature of a wireless environment. The scheduler 708 may also decide user pairing and may work with a multi-user grouping engine 706 to generate user groups that can be simultaneously served with a same transmit beam, or conversely, can share a same uplink beam.

The scheduler 708 may further include a queue management function for scheduling data transmissions based on received hybrid automatic repeat request (hybrid ARQ or HARQ) response from UEs or transmit queue statuses of UEs. A traffic policy function 710 may be used to control overall user data allocation for transmission/reception. This function may, for example, ensure that the MU-MIMO transmission grouping is performed according to a network slice instance allocated to each UE.

For example, in some embodiments, the user localization, autocalibration, uplink signal separation and downlink spatial multiplexing may be performed using the following steps.
(1) Acquire channel fingerprint relative to adjacent base stations using available emitted UE reference signals in time frequency and space
(2) Derive location from acquired channel fingerprint relative to each base stations as well as motion speed and direction.
(3) Derive direction to Auto Calibrate Antenna array for each base station.
(4) Calculate coefficients for any desired spatial filtering (beamforming and null steering)
(5) Apply Spatial filtering and calibration to track user & enhance reference acquisition
(6) Apply Spatial filtering and calibration to separate Up-Link users' signals
(7) Apply Spatial filtering and calibration to spatially multiplex Down-Link users
(8) Learn feature map (capacity, Interference, LOS condition, user density, traffic, etc . . . )

Example steps for antenna calibration may include:
(A) Find Maximum Likelihood Location for each user based on Acquired Channel state Information from participating base stations
(B) Find maximum likelihood Velocity vector for each user based on Acquired Channel state Information from participating base stations
(C) Find Maximum Likelihood Angle to each user relative to participating base stations
(D) Estimate channel sparse representation
(E) Calibrate each antenna Gain/phase for every tone.

In some embodiments, the above-described network management functions may further be used for managing cooperative multipoint operation and performing handover in the wireless network. For example, the following operations may be performed:
(1) Using interference (feature) map and user specific location Handover decision could be enhanced significantly
(2) Geometry based CoMP (coordinated multi-point) based on traffic activity along with user attributes database

### 3 Examples of Antenna Calibration

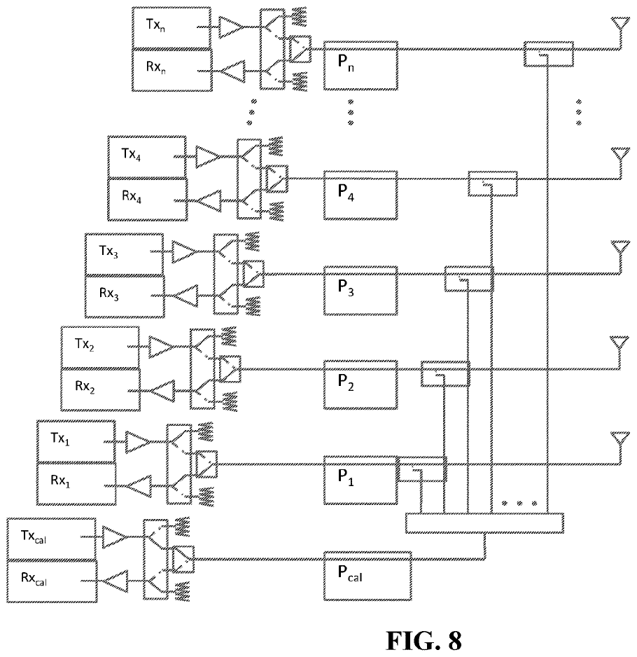

FIG. 8 depicts an example circuit for antenna calibration. For a number n of antennas (shown on right side of the drawing), the antennas are electrically coupled to corresponding transceivers. The signals from/to the antennas are also coupled to a calibration transceiver through a muxing circuitry that is used during calibration signal transmission or reception. The calibration circuitry may be internal to the device in such embodiments.

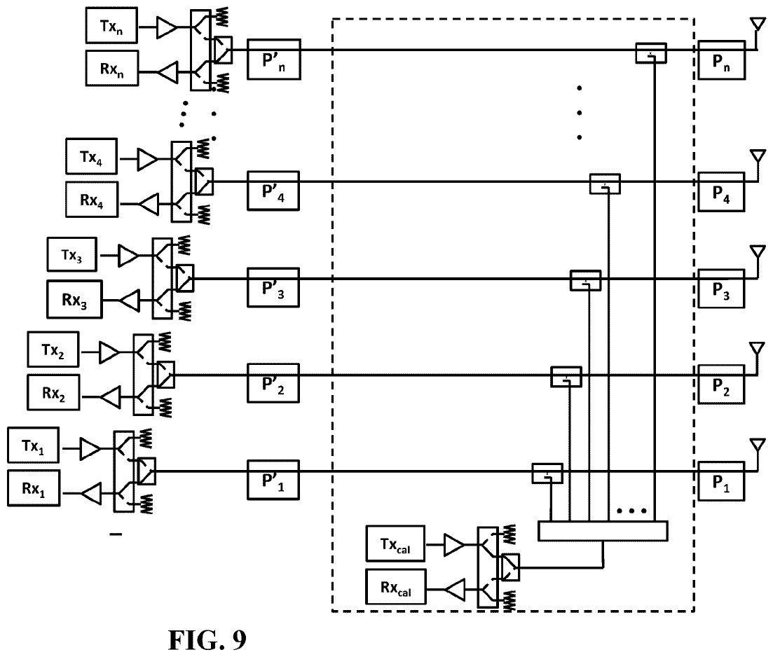

FIG. 9 depicts an example implementation in which an external calibration box is used for external antennas. The box is shown at the bottom of the picture and may use all other transmit/receive chain except for the actual antenna elements over which other UEs communicate with the network device.

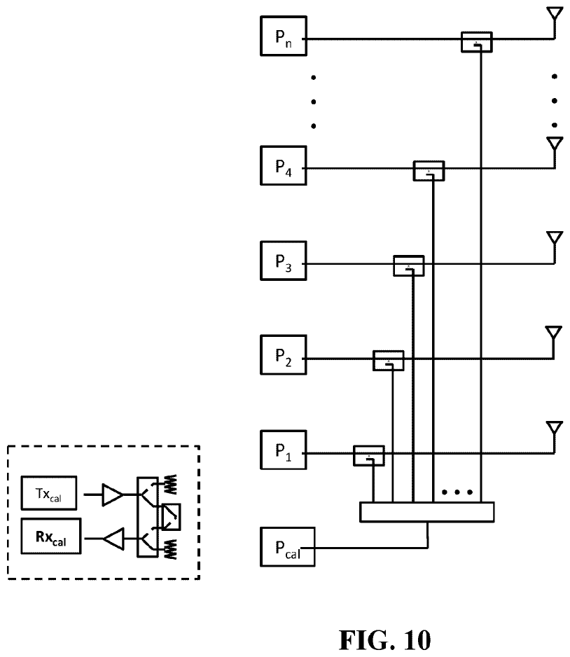

FIG. 10 shows an example implementation of antenna calibration port such as shown in FIG. 9.

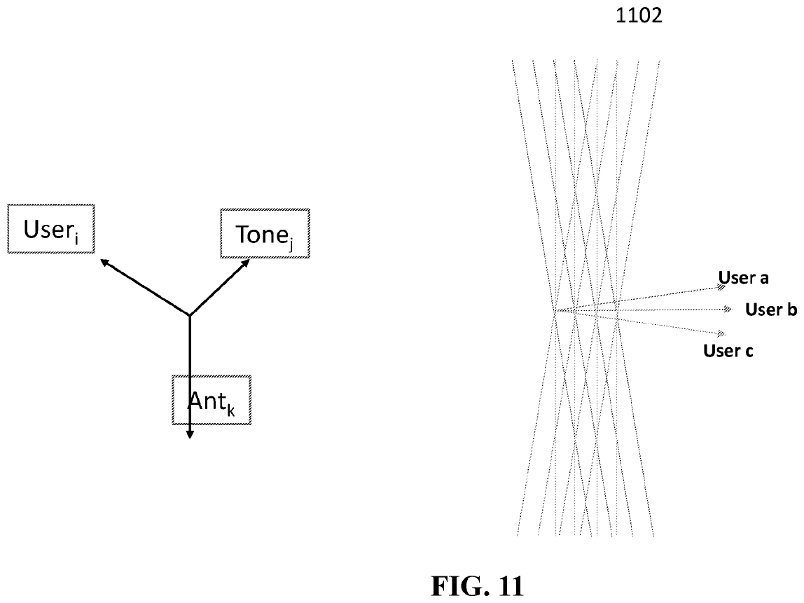

FIG. 11 depicts examples of antenna gain or phase misalignment. As shown on the left, various localization measurements may be performed along three different independent axes—for multiple user devices, denoted as users(i), at multiple frequencies or tones, shown as tones(j) and for multiple antennas (ant). The concept of antenna gain or phase misalignment as depicted in example 1102. The parallel lines of each color represent waveform traveling along a direction, intended to/from users a, b or c. Ideally, these waveforms will be traveling from left to right. However, for users a and c, due to antenna misalignment, the waveform direction is slightly off—which would result in a slightly different gain and phase of the received (or conversely transmitted) signal for these user devices.

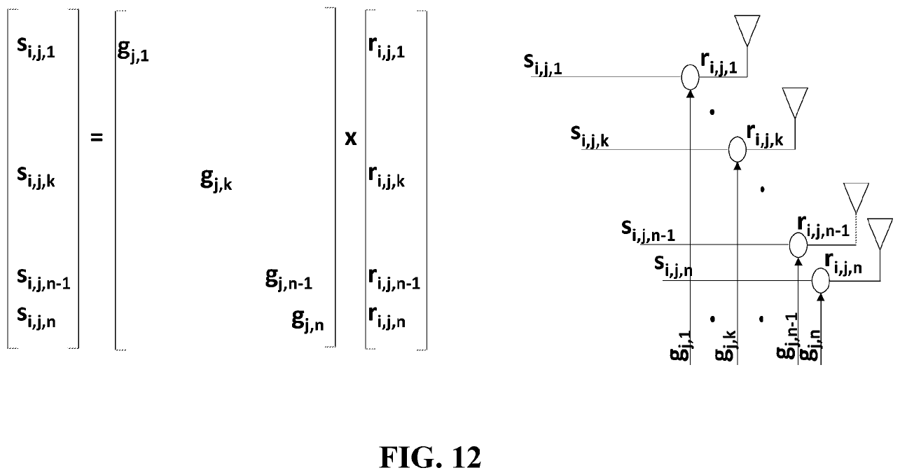

FIG. 12 depicts an example implementation of determination of antenna gain and phase misalignment. The distortion due to misalignment may be represented as a matrix multiplication of three matrices—S, G and R. Here, the entries of the S matrix represent actual signal transmissions that are obtained by multiplying the observed signal values r with a corresponding gain factor g. The symbols s are indexed using a triplet of indices—representing positions (i,j) of user devices and antenna index n.

### 4 Examples of Geometric Location Determination

FIG. 13 shows an example configuration of three wireless cells in which receiver localization and calibration is performed. The dashed triangle in the middle represents a region of the wireless network with dots representing various wireless devices operating within the cell. In some embodiments described in the present document, active users, whose wireless device will be frequently transmitting or receiving data from one or more of the base stations (shown at the center of the hexagons) may be used for calibrating antennas.

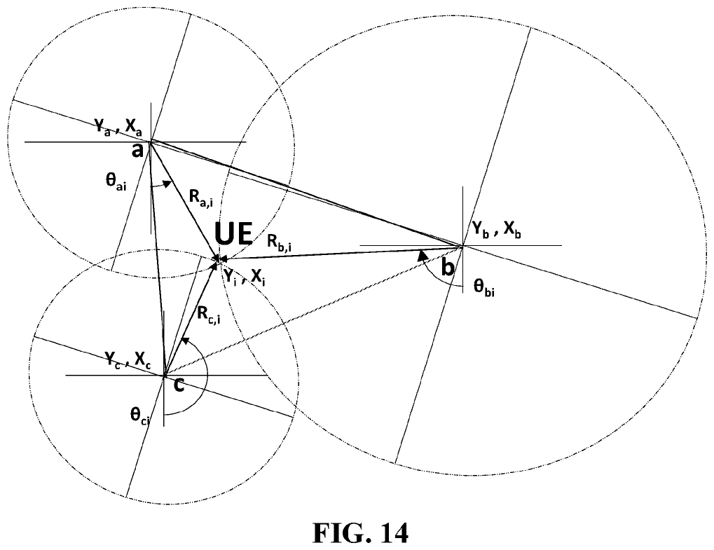

FIG. 14 shows an example implementation of a trilateration process. At a UE, signals from three base stations a, b and c may be received. Based on the strength of the received circle and know attenuation characteristics of the transmission medium (e.g., air), an isobar can be drawn around each base station indicative of the locations at which the signal strength would be equal to the signal strength seen and reported by the UE. In FIG. 14, this isobar is shown as a circle for simplicity. The common intersection point of the three circles identifies the location of UE based on signal measurements.

Once UE location is known, denoted as (Xi, Yi), that information may be used along with locations of the base stations a, b, c, which are denoted as (Xa, Ya), (Xb, Yb) and (Xc, Yc), this information can be used to estimate an angle of orientation based on the straight line connected between the UE location and each base station. The straight lines are denoted as Rai, Rbi and Rci, respectively. Based on the estimated angle of orientation, and measurements from received signals, a difference between actual (observed) angle of orientation and the estimated angle of orientation based on the position of UE can be calculated (angles 6, denotes by subscripts with base station and UE identities). This difference provides an estimate of angular misalignments of the antenna arrays for each base station a, b and c, respectively.

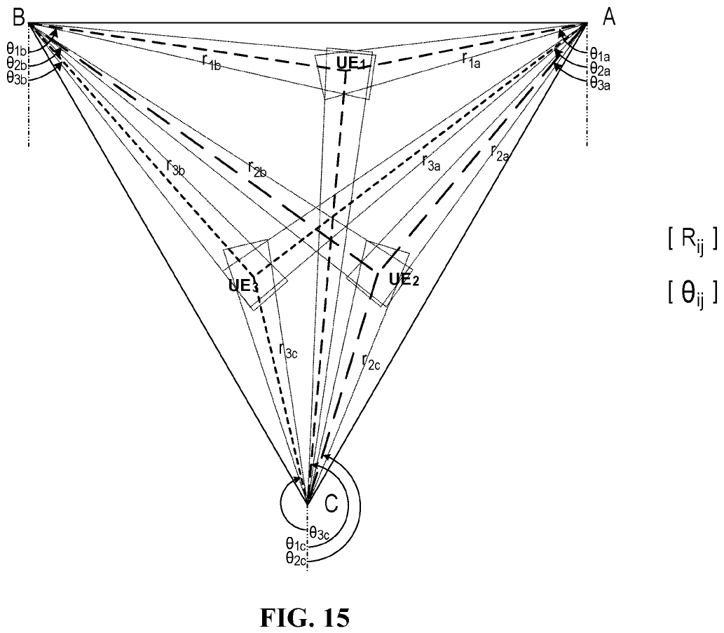

FIG. 15 shows an example implementation of receiver triangularization in a wireless network. The process described with respect to FIG. 14 may be repeated for several available UEs in the common coverage area (UE1, UE2 and UE3, in this example), to estimate the respective distances [Rij] and angles of orientations [θij] of UEs within the coverage area.

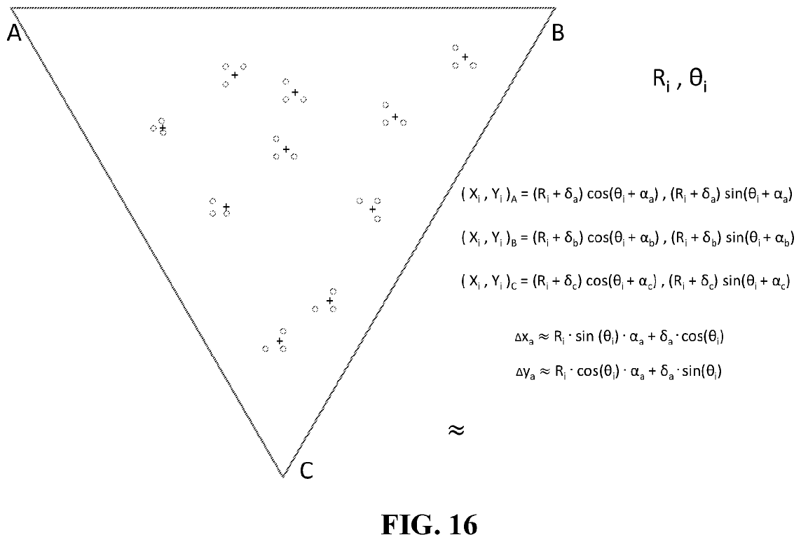

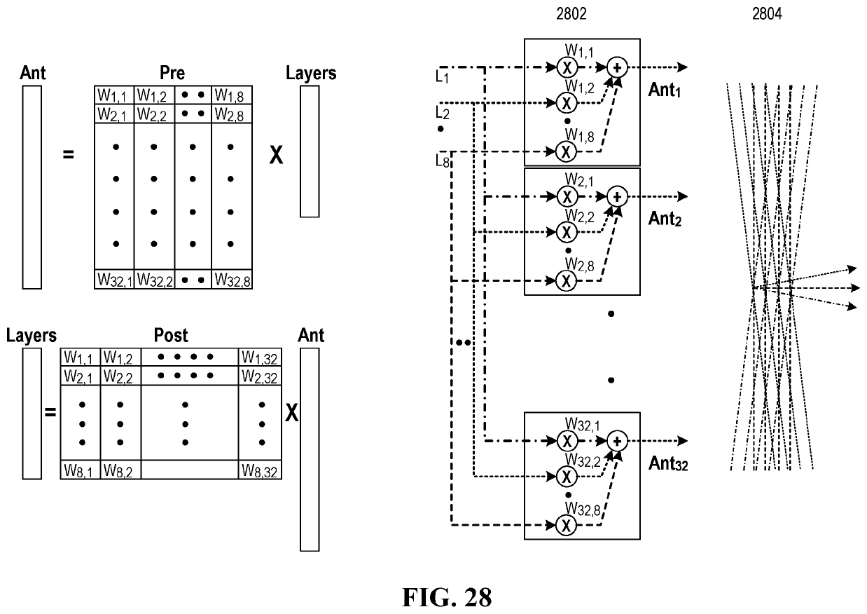

FIG. 16 shows an example implementation of receiver localization. The various equations show one implementation of estimation of localization error estimation. For example, at the transmitter, antenna mapping may be achieved by showing the operation as a mathematical multiplication of a precoding coefficient matrix with various layers of data streams being transmitted (two are shown in FIG. 28). At the receiver side, the generation of layers from the signaled received on multiple antennas can similarly be represented as a matrix multiplication with a post-coding matrix. The multiplications may be implemented as shown in 2802. The result of the precoding or postcoding may be seen as transmissions in different directions, as shown in wavefronts 2804.

Here, the calculations may be performed using the following equations:

$${( {X}_{i} , {Y}_{i} )}_{A} = ( {R}_{i} + {δ}_{a} ) cos ( {θ}_{i} + {α}_{a} ) , ( {R}_{i} + {δ}_{a} ) sin ( {θ}_{i} + {α}_{a} )$$

$${( {X}_{i} , {Y}_{i} )}_{B} = ( {R}_{i} + {δ}_{b} ) cos ( {θ}_{i} + {α}_{b} ) , ( {R}_{i} + {δ}_{b} ) sin ( {θ}_{i} + {α}_{b} )$$

$${( {X}_{i} , {Y}_{i} )}_{C} = ( {R}_{i} + {δ}_{c} ) cos ( {θ}_{i} + {α}_{c} ) , ( {R}_{i} + {δ}_{c} ) sin ( {θ}_{i} + {α}_{c} )$$

$$Δ {x}_{a} \approx {R}_{i} \cdot sin ( {θ}_{i} ) \cdot {α}_{a} + {δ}_{a} \cdot cos ( {θ}_{i} )$$

$$Δ {y}_{a} \approx {R}_{i} \cdot cos ( {θ}_{i} ) \cdot {α}_{a} + {δ}_{a} \cdot sin ( {θ}_{i} )$$

Here, (x, Y) represent cartesian coordinates of respective UE A, B or C. The radius R and angle θ respectively represent rotational coordinate with variables delta and alpha representing distance measurement inaccuracy and phase (or angle) measurement inaccuracy). The relationship between angular measurements and X-Y coordinate measurements are shown by the last two equations.

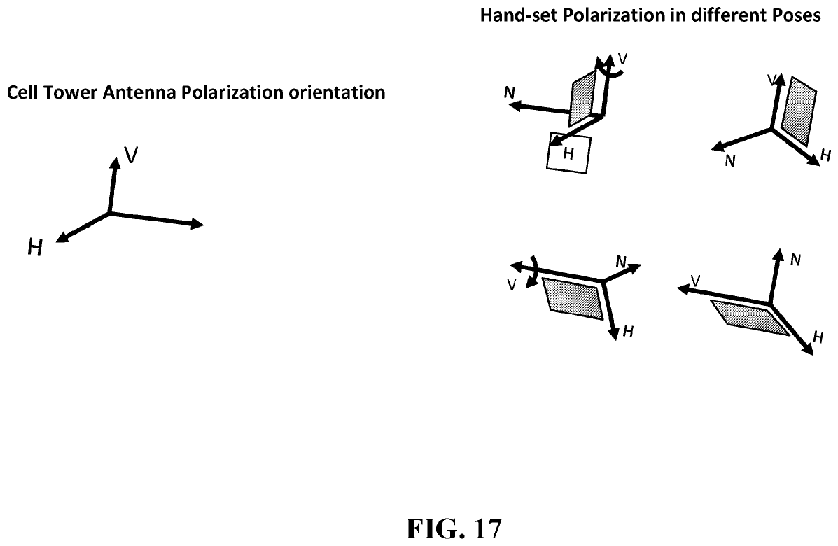

FIG. 17 shows an example of pose or orientation estimation of a user equipment (UE). Because the techniques disclosed in the present document provide for precise implementation of range and phase calculation, a pose of a UE may be continuously tracked based on the angles of reception of different layers of signals from UE. The knowledge of rotational properties of the UE may be used on the network side for better scheduling, grouping and tracking the UE. For example, UE's pose may be used for deciding the rank or PMI used for transmission to/from the UE.

In some embodiments, the antenna bias measurements may be used for measuring a UE's orientation or pose as a function of time. This information may be used for predicting the UEs movement for allocating transmissions rank and/or precoding transmissions to or from the UE. Furthermore, such information may be of interest to certain higher layer apps such as a health or fitness app and may be made available to the apps via a network server API. Some examples are described with respect to FIG. 17.

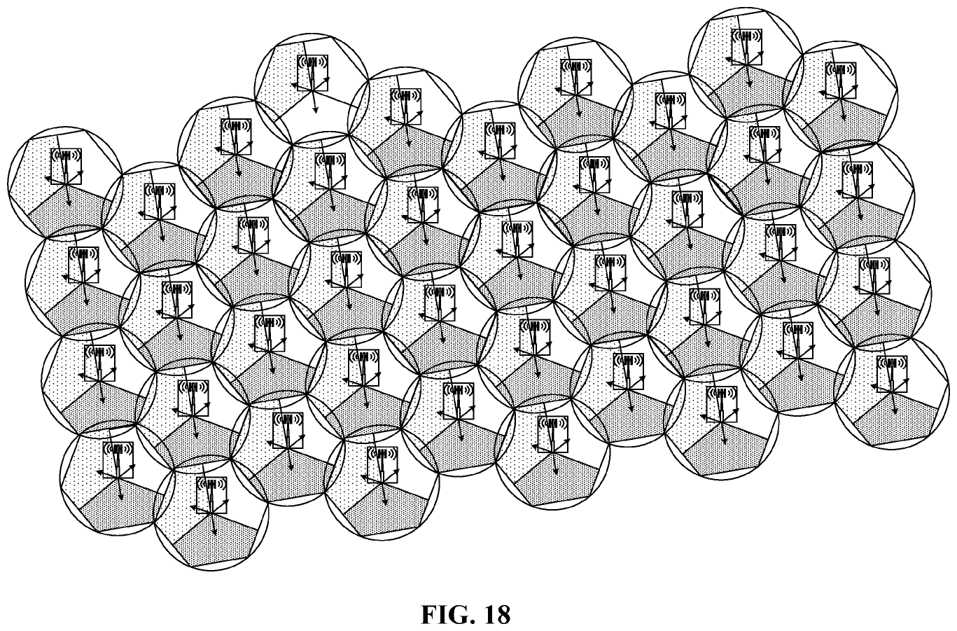

FIG. 18 shows an example of a wireless network that is spread across a wide geographic region. The various techniques described in the present document may be implemented in such networks that may span across a vast geographic area such as an entire city, county, a country or an entire continent.

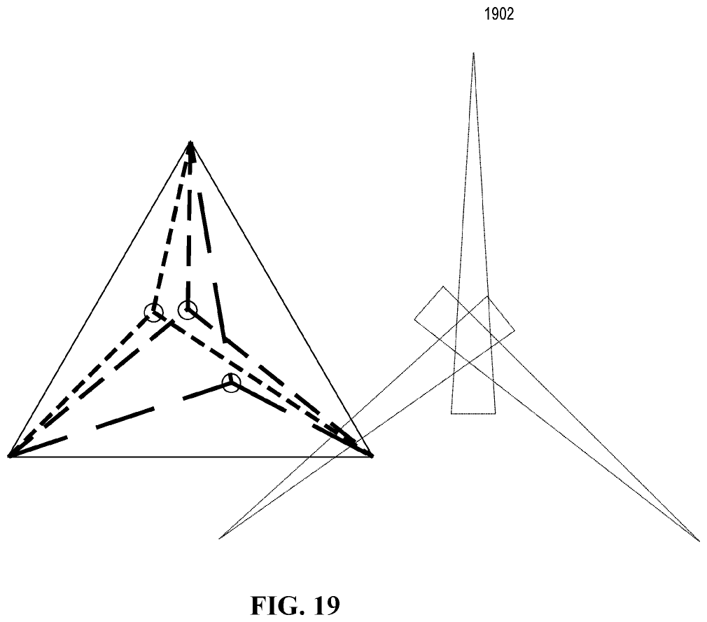

FIG. 19 shows an example of triangularization of receivers in a wireless communication cell. As can be seen in the drawing, three UEs are in a coverage area of three base stations. Inaccuracy in the estimation of each base stations antenna direction may introduce grow as a distance from the base station, as show in the drawing 1902, by beams that become wider away from the base station. Thus, antenna calibration may directly impact how accurately a UE can be localized using the techniques described in the present document.

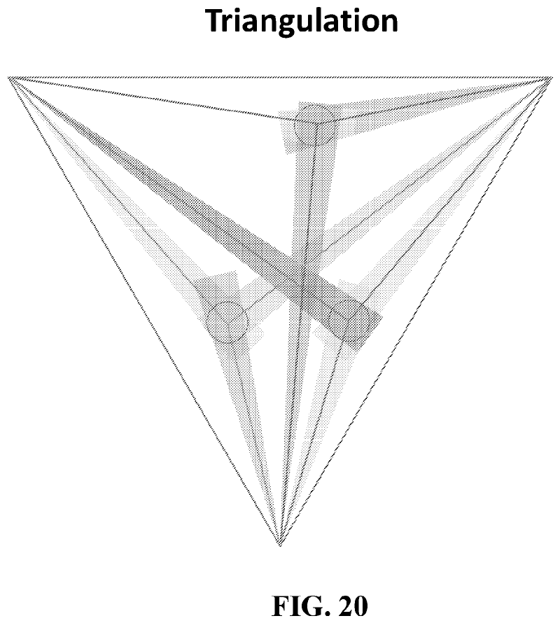

FIG. 20 shows another example of triangularization using the accurate calibration to achieve better localization.

FIG. 21 shows an example of an implementation of passive tracking. As a UE moves around the coverage area, the base stations may be able to estimate how soon a UE may needed to be handed over and which is the best base station to handle the handover.

Various techniques described in the present document may be used to provide improvements to wireless network operations.

In one example aspect, the disclosed localization techniques may be implemented using existing UEs, with no changes to current wireless standards such as 5G, by providing techniques for geometric precoding to increase amount of throughput of a wireless network over traditional implementation.

### 5 Examples of Signals Used for Measurements

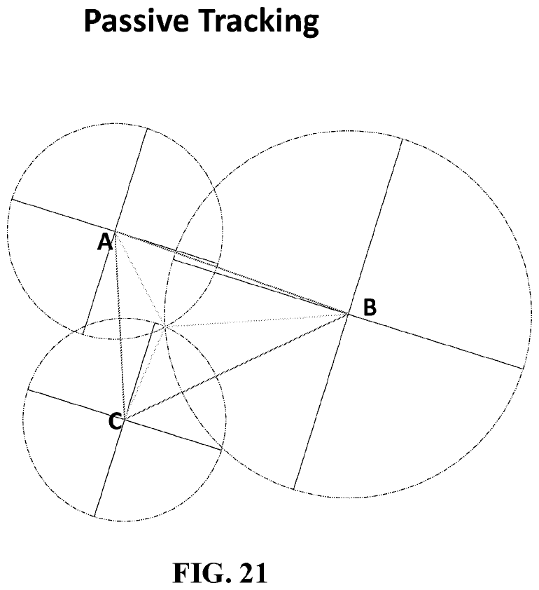

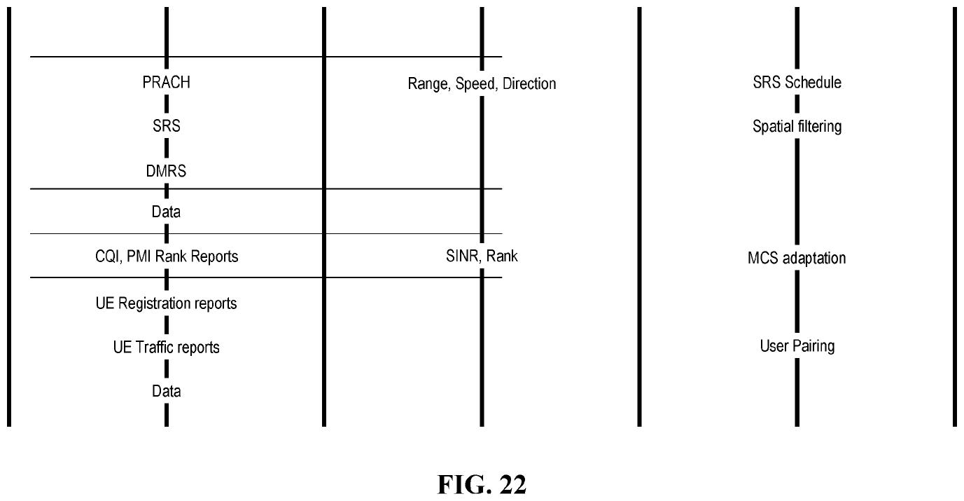

FIG. 22 shows a listing of various transmissions in a wireless network that may be used for performing measurements and subsequently used for making scheduling or other decisions for network operation. The signals include PRACH (physical rando access channel), SRS (sounding reference signal), DMRS (demodulation reference signal), data transmissions, CQI and PMI rank reports, UE registration reports, UE traffic reports, and so on. The middle column shows that these transmissions could be used for determining range, speed and direction of the UE. These transmissions may further be used to determined SINR and rank for transmission with UEs and also the geographic position at which the UE is located. The accumulation of these measurements can be used for SRS scheduling, spatial filtering for beamforming, modulation and coding scheme (MCS) adaptation, and grouping of users.

### 6 Examples of Scheduling

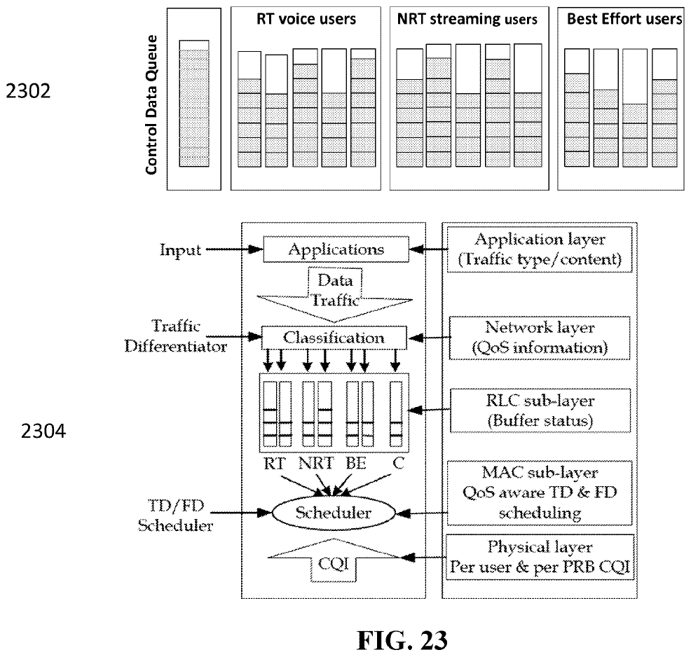

FIG. 23 shows an example stack implementing wireless data communication. The stack may be able to handle various types of data traffic according to the required transmission qualities. An example is shown in Table 1.

TABLE 1

| | Transmission | |
|---|---|---|
| Traffic type | requirement | Example |
| Control data | High priority | Scheduling information |
| Real time (RT) | Low latency | Voice |
| Non real time (NRT) | High throughput | Streaming video |
| Best effort (BE) | Low priority | Email, SMS |

2302 pictorially depicts an example of a control data queue that includes various types of data transmissions as above.

2304 shows a stack of various Open Systems Interconnection (OSI) layers, including an application layer, a network layer, a radio link control (RLC) sub-layer, a medium access control (MAC) sublayer, and a physical (PHY) layer. These layers of the stack are correspondingly responsive for implementing the following functions.

TABLE 2

| Layer | Function |
|---|---|
| Application layer | Generate / provide data traffic having type |
| | according to applications |
| Network layer | Includes QoS information and classifies data |
| | according to the QoS information to differentiate |
| | traffic of each type |
| RLC sublayer | Provide separate queues for different data types |
| MAC sub-layer | QoS aware sublayer that is responsive to time or |
| | frequency duplexed scheduling for various data |
| | type ques according to a scheduler |
| Physical layer | Map or decode data on a per user, per physical |
| | resource block basis according to channel quality |

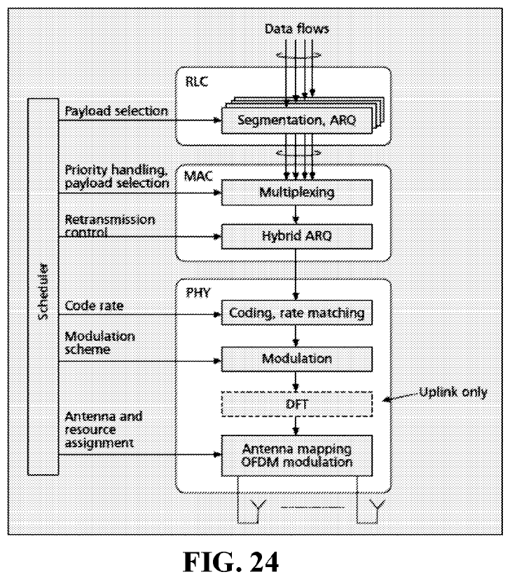

FIG. 24 shows another example stack implementing wireless data communication. In this embodiment, data flow occurs as follows under the control of a scheduler. Data from higher layers (e.g., app layer) is input to a segmentation and automatic repeat request function in the RLC layer. The output of RLC layer is input to a MAC layer that implements multiplexing and hybrid ARQ (HARQ) function. Data is then passed between the MAC layer and PHY layer for performing coding and rate matching, followed by modulation mapping followed by discrete Fourier transform application (for uplink transmissions) and mapping to antenna for transmission. Similar functions are repeated in reverse for receive side. Various control signals provided by the scheduler at each stage of the data pipeline are also depicted in FIG. 24.

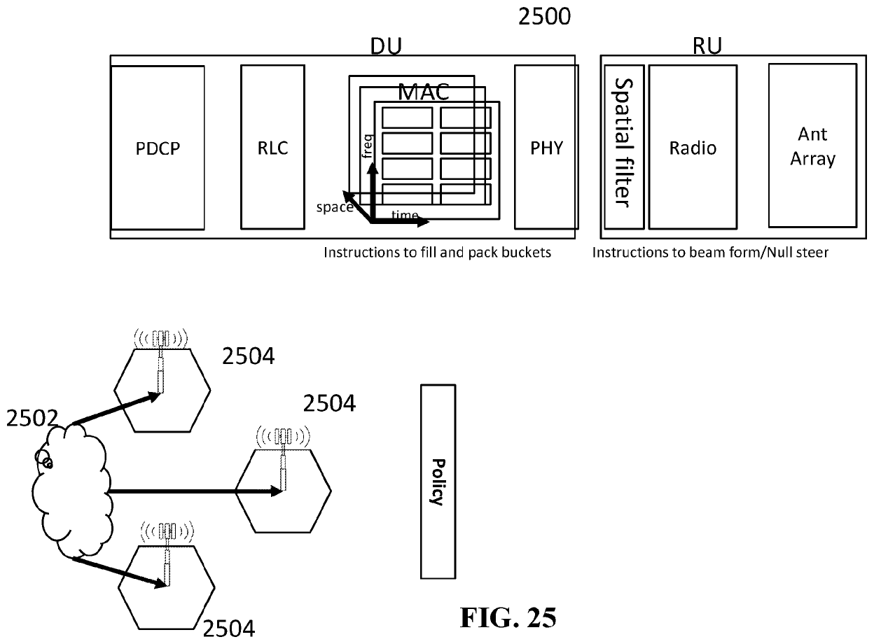

FIG. 25 shows an example of architecture of a cooperative multipoint (COMP) network operation and an implementation of a communication device 2500 in such a network.

The COMP network includes cells 2504 with their individual cell towers or base stations, all in communication with each other through a core network 2502. Collectively, the network may implement a policy for scheduling and grouping of UEs based on localization data.

An example network device 2500 may be implemented as DU-RU logical partitioning. Here, the RU partition includes an antenna array for MIMO communication, a radio for transmission and reception of RF signals and a spatial filter to be able to receive or transmit spatially selective signals such as transmission beams. The RU may be responsive to instructions for beam forming or null steering.

The DU may include a protocol stack implementation that includes a packet data convergence protocol (PDCP) layer, an RLC layer, a MAC layer and a PHY layer. Of note is the MAC layer that may be able to transmit and receive data that is multiplexed along time, frequency and space dimension-based transmission resources (e.g., different time slots, different frequency tones and difference spatial layers).

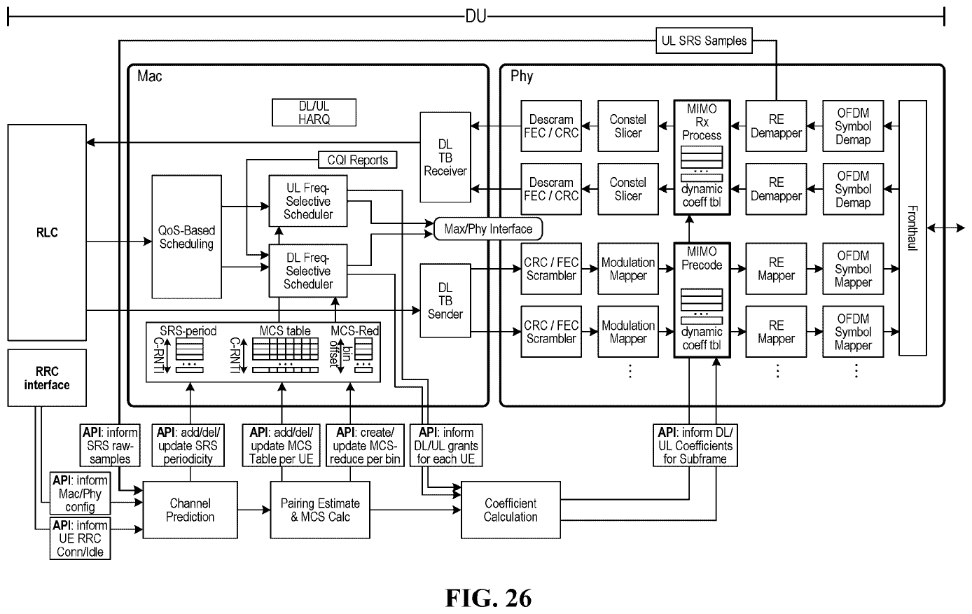

FIG. 26 shows an example implementation of MAC, PHY and RLC layers of a MIMO DU and various application programming interfaces (APIs) among these layers of the implementation stack. The drawing shows MAC and PHY layer functions implemented separately and communicating via a MAC-PHY interface.

The following functions are included in the MAC. A DL/UL HARQ function for implement hybrid automatic repeat request functionality in the downlink and uplink directions. A UL TB receiver that is configured for receiving uplink transport blocks. This block will provide CQI reports to a DL frequency-selective scheduler. An UL frequency selective scheduler block generates schedules for UL. Both these blocks communicate with the PHY layer via the MAC PHY interface. Both these blocks are controlled by an input from a QoS based scheduling function that receives commands from the RLC layer. The schedulers use and specify various transmission resources such as MCS tables, SRS period, and so on.

At the PHY layer, one or more receive chains may receive signals via a fronthaul connection, and perform OFDM symbol demapping, followed by remapping, a MIMO Rx process for separating out MIMO data streams, a constellation slices and a descrambler, forward error correction and cyclic redundancy check function. In the transmit chain, data from a transport block sender may be processed through forward error correction, scrambler and cyclic redundancy check addition, converted into symbols via a modulation mapper, and processed through a MIMO precoder. The output of the MIMO precoder is processed through a remapper, and OFDM symbol mapper and further processed in RF domain for transmission on the fronthaul.

Adjunct to the MAC and PHY, a radio resource control (RRC) layer operation and other system functions may be coupled to various functionalities of MAC and PHY via APIs, including APIs to inform SRS raw samples to channel prediction, APIs to add/delete/update SRS periodicity from channel prediction to MAC, APIs to add/delete/update MCS table per UE from a pairing estimate and MCS calculation, APIs to create or update MCS-reduced per bin, based on pairing estimation, APIs to inform MAC/PHY configuration to a channel estimation function, and APIs to inform the MAC/PHY of the RRC state (connected or idle). Furthermore, a coefficient calculation function that estimates precoding coefficients will provide this information via APIs to the DL/UL processing on a subframe basis.

### 7 Examples of Wireless Device Multiplexing

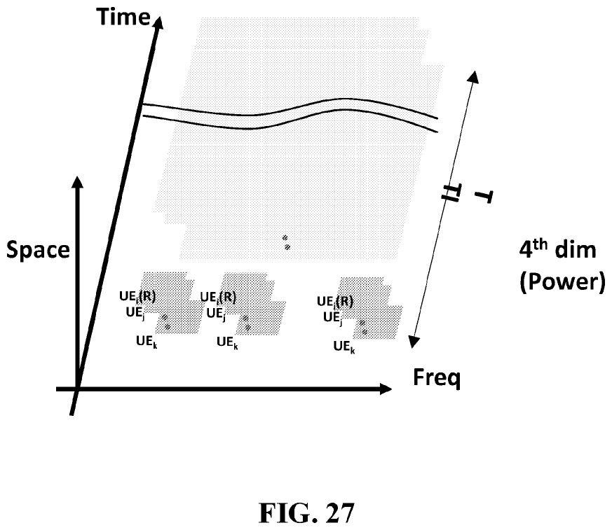

FIG. 27 pictorially depicts an example of time, frequency and space multiplexing of data traffic for multiple users. The three orthogonal axes depict time, frequency and space, with each UE being assigned one or more contiguous portions in such a space. A fourth dimension of power may also be used to manage interference levels among various transmissions.

FIG. 28 pictorially depicts an example implementation of spatial filtering in wireless communication. On the transmit sides, mapping to antenna is performed based on a precoding matrix (Pre) operated upon layers of data transmissions. On the receive side, a postcoding operation is used to separate layers of data from signals received on multiple antennas. This operation is pictorially depicted as a signal flow 2802. The resulting signals 2804 are depicted as three layers of transmissions that simultaneously take place without cross-interference.

### 8 Examples of Solutions Provided by the Disclosed Technology

As discussed herein, antenna misalignment may cause errors in gain and phase measurements in wireless systems which may lead to sub-optimal operation. Accordingly, in some embodiments, antenna bias or misalignment of one transmission tower (or base station) may be estimated and eliminated at UE positions by using transmissions from other neighboring base stations. Some example implementations have been described with reference to FIGS. 14 and 15 and may be implemented using an apparatus as discussed with respect to FIG. 4 or 5.

### 9 Localization and Antenna Calibration Solutions

One advantageous aspect of antenna bias removal by measuring antenna orientation is that, during this operation, triangularization or trilateralization may be used for also estimating UE locations. Furthermore, accuracy of UE location estimation may be improved using an iterative process in which a UE location is first estimated, then used for antenna calibration, and then UE location is estimated again based on the calibrated antenna. This process can be iterated a number of times until no further improvement is obtained in the calibration and location estimate.

As further described in the present document, the knowledge of UE positions may be advantageously used for pairing UEs so that communication between paired or grouped UEs and the base station can be done in a space division duplexed manner on a same beam. The UEs in a same group may share transmission resource via frequency, time, code or layer domain duplexing.

### 10 Examples of Feature Mapping a Wireless Coverage Area

In some embodiments, the calculations and results from the antenna calibration and UE localization may be collected in a network database for statistics and analysis. For example, a network-wide parameterization of signal to noise ratio (SNR) profiles of UEs as they move around may be maintained. In addition, a feature map of the network may be generated based on SNR and channel estimation performed at each location as various UEs occupy the location over a period of time. Ideally, this databased includes entries from multiple UEs for each (x, y) location in the network. Measurements of each UE at a given location (x, y) may be weighted relative to the UE's performance accuracy across the network in comparison to other UEs. Some examples of measurements performed in the network are described with reference to FIGS. 14, 15, 11, 12, 22, 28, 29 and so on.

### 11 Examples of Network Bandwidth Management

In some embodiments, a feature map of the network is generated by mapping interference estimates, path losses, time profiles and so on. The time profile may, for example, generate time-dependent characteristic of a location such as peak crowding times or relatively sparse times (e.g., when a café store is closed). Such a feature map may be advantageously used on the network-side to schedule transmission resources, using deployment of base stations to serve a certain area, making additional bandwidth available by increasing power in certain directions at certain times, and so on.

In some embodiments, the various operational parameters collected on the network side may be used for geometric pre-coding to achieve accurate spatial separation. Accordingly, the tasks of calibration data collection, processing, and application to scheduling could be done in a distributed manner. For example, as shown in FIG. 5 and FIG. 25, different base stations or distributed units DUs may be used for scheduling according to the antenna calibration of the base station and UE location data. FIGS. 23, 24 show example implementations of data flow management in a protocol stack architecture. FIG. 22 shows that these schemes do not need special signals; legacy reference signals and other transmissions may be used for antenna calibration and UE localization. For example, base stations in a region (e.g., FIGS. 25, 18) may be connected via a backbone connection that provides a high speed low latency (less than 10 msec) connection for transfer of localization and channel quality data to enable a frame-based scheduling in a distributed manner.

In some embodiments, the localization data for UEs and the network feature map may be used to prepare for an upcoming handover by allocating transmission resources to a UE for an upcoming time period, prior to the UE actually being a part of a network.

### 12 Examples of Fractional Beam Scheduling

In some embodiments, a plurality of groups may be determined by grouping user devices, where each of the plurality of groups corresponds to one of multiple transmission beams, partitioning user devices in each of the plurality of groups into one or more sub-groups according to a transmission metric or a geometric property for each user device. In an example, the transmission metric is a measure of a wireless channel between a network node and the corresponding user device. In another example, the geometric property is the angle of arrival as described in this document. Scheduling transmissions between the network node and the user devices may be based on time-multiplexing and multiplexing the multiple transmission beams, where a difference between the transmission metrics or geometric properties of user devices served at a same time or using a same transmission beam is above a threshold.

The described techniques can be used to increase the efficiency of scheduling transmissions in a beam-based wireless communication system. For example, embodiments may achieve this increased efficiency by first grouping user devices into groups such that each group can be served by a transmission beam. Each such group may further be divided into fractions (e.g., 2 or more groups) of user devices using a metric of transmission paths between the network node and the user devices. Then, transmissions may be scheduled to occur for each transmission beam to serve a user device in the subgroup, thereby having a fractional use of each beam for each group.

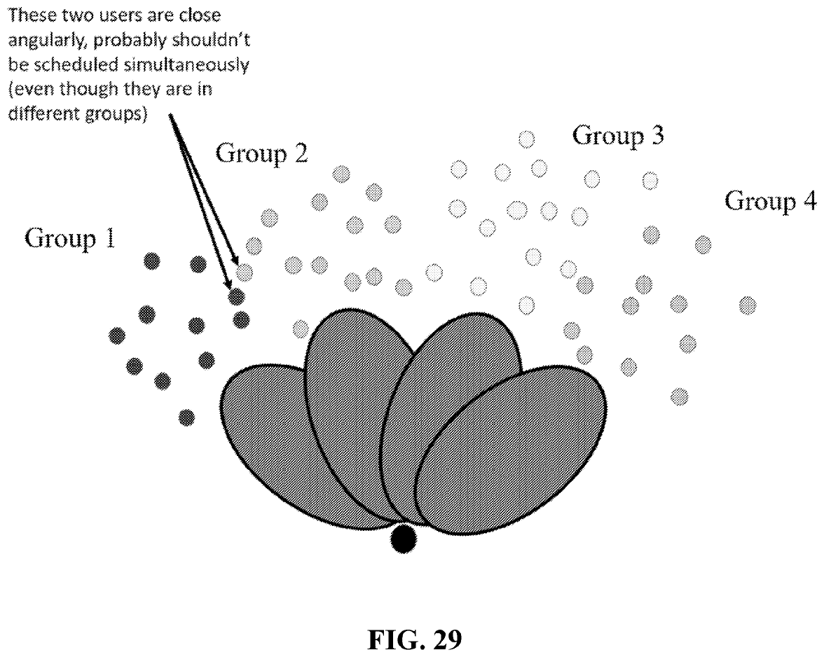

FIG. 29 shows an example of scheduling multiple transmission beams for a plurality of user devices divided into different groups. As shown therein, Groups 1-4 comprise spatially separated user devices, such that the user devices (or users) in each group are covered by a single transmission beam. However, if two users with an angular separation that is lower than a threshold are selected from different groups, the resulting simultaneous transmission to these users would result in degraded performance due to high interference levels. Thus, a separation into groups based on the transmission beam may result in degraded transmissions.

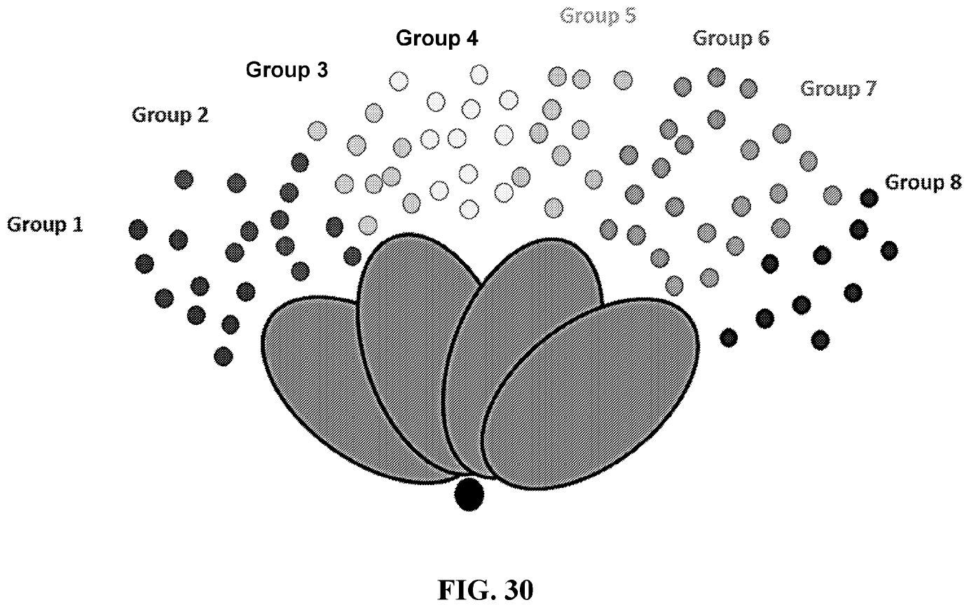

FIG. 30 shows another example of scheduling multiple transmission beams for a plurality of user devices divided into groups and sub-groups. As shown therein, Groups 1-4 shown in FIG. 29 are halved and result in Groups 1-8, wherein two adjacent groups are covered by a single transmission beam. For example, Groups 1 and 2 are covered by a first transmission beam, and Groups 5 and 6 are covered by a third transmission beam. As will be described next, doubling the number of groups (referred to, in an example, as “half beam groups”) may result in better performance.

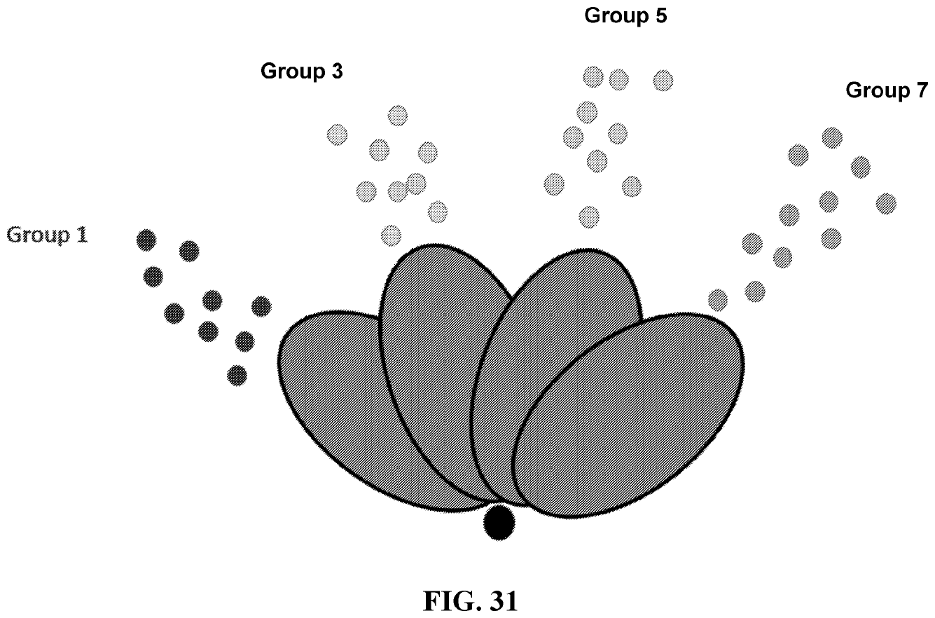

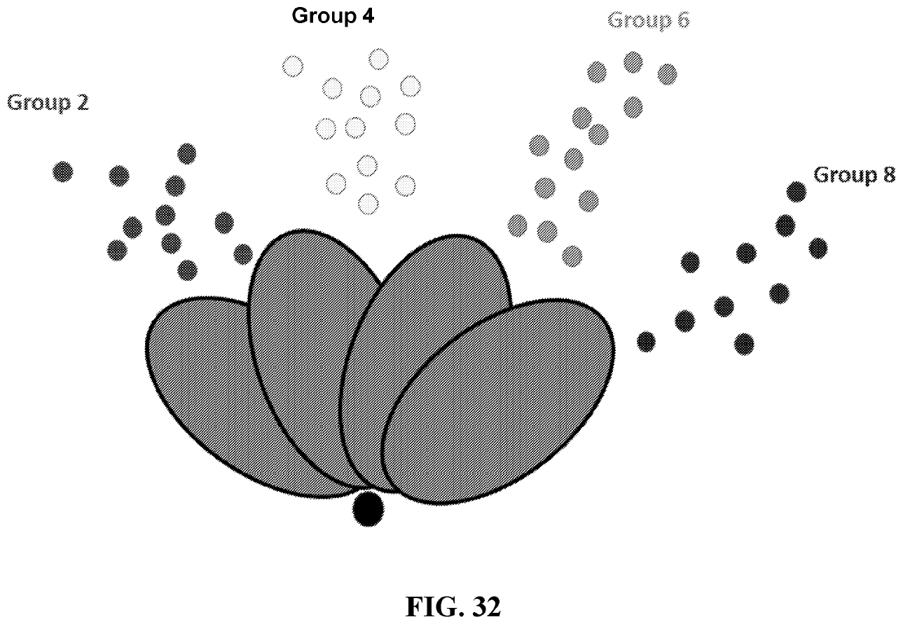

FIGS. 31 and 32 shows an exemplary embodiment for scheduling multiple transmission beams, based on time-multiplexing, for a plurality of user devices. For example, the network node may simultaneously transmit to users (or user devices) in Groups 1, 3, 5 and 7 at a first time (as shown in FIG. 31), and to users in Groups 2, 4, 6 and 8 at a second time (as shown in FIG. 32). That is, users that are served at the same time have transmission metrics that are greater than a threshold. In an example, the threshold may be determined based on an intended level of interference that may be tolerated at the user devices. In some embodiments, the level of interference may be quantified using the signal-to-noise ratio (SNR) or the signal-to-interference-plus-noise ratio (SINR).

In some embodiments, user devices in the “half beam groups” may be scheduled simultaneously based on the transmissions being precoded (e.g., using Tomlinson-Harashima precoding vectors) at the network node, and the user devices implementing joint equalization techniques to process the received signals.

In some example embodiments, fractional beam scheduling may be performed as follows. Let T1, T2, T3 and T4 be four transmission beams in a wireless communication network. User devices may be partitioned into corresponding four groups A, B, C and D such that the transmission path for each user device in one group corresponds to a same transmission beam (e.g., all user devices in group A use T1, all user devices in group B use T2, and so on).

According to some embodiments, the groups A, B, C and D may further be divided into multiple sub-groups. For example, A1, A2, B1, B2, C1, C2 and D1, D2 respectively. This grouping may be performed such that corresponding sub-groups in each group are isolated from each other by a transmission metric (e.g., their cross-effect, measured as SINR, is below a threshold). As an example, sub-groups A1, B1, C1 and D1 may form a first partition, while A2, B2, C2 and D2 may form a second partition. Therefore, a scheduler may schedule transmissions for all user devices of sub-groups in the first partition to occur at the same time, while being assured that the relative isolation between these transmissions will be maintained. Similarly, in a next time slot, the scheduler may schedule transmissions for user devices from the second partition, and so on, as described with respect to odd/even grouping in FIG. 29. Accordingly, it will be appreciated that using only a fraction of a group served by a transmission beam at a given time results in an overall improvement in the quality of signal transmissions received by user devices and the network node.

The disclosed techniques can be used by a scheduler in a multi-beam transmission system for improving quality of signal transmissions by partitioning user devices into sub-groups such that transmissions may be scheduled to occur via transmission beams to/from the sub-group of devices and a network node while at the same time ensuring that the user devices in the sub-group are isolated from each other to ensure interference to each other's transmissions stays below a threshold such as an SINR threshold. It will further be appreciated that these sub-groups are formed such that (1) user devices in the sub-groups of a given group all use a same transmission beam (at different times) and (2) user devices from different groups are partitioned into sub-groups based on a transmission metric or a geometric property.

### 13 Examples of Channel Prediction at Different Times and/or Frequencies

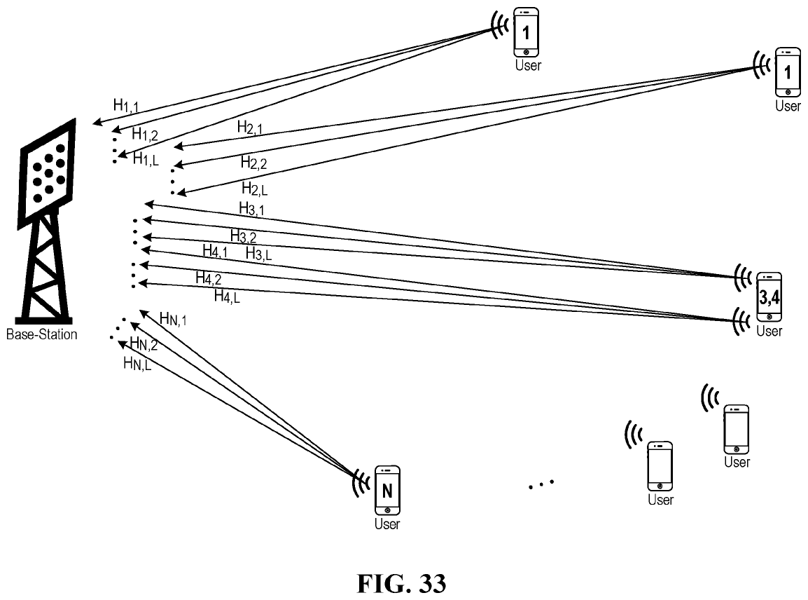

Embodiments of the disclosed technology are further directed to channel estimation for OTFS systems, and in particular, aspects of channel estimation and scheduling for a massive number of users. A wireless system, with a multi-antenna base-station and multiple user antennas, is shown in FIG. 33. Each transmission from a user antenna to one of the base-station antennas (or vice versa), experiences a different channel response (assuming the antennas are physically separated enough). For efficient communication, the base-station improves the users' received Signal-to-Interference-Noise-Ratio (SINR) by means of precoding. However, to precode, the base-station needs to have an accurate estimation of the downlink channels to the users during the transmission time.

In some embodiments, and when the channels are not static and when the number of users is very large, some of the challenges of such a precoded system include:
Accurately and efficiently estimating all the required channels
Predicting the changes in the channels during the downlink transmission time

Typical solutions in systems, which assume a low number of users and static channels, are to let each user transmit known pilot symbols (reference signals) from each one of its antennas. These pilots are received by all the base-station antennas and used to estimate the channel. It is important that these pilot symbols do not experience significant interference, so that the channel estimation quality is high. For this reason, they are typically sent in an orthogonal way to other transmissions at the same time. There are different methods for packing multiple pilots in an orthogonal (or nearly-orthogonal) way, but these methods are usually limited by the number of pilots that can be packed together (depending on the channel conditions) without causing significant interference to each other. Therefore, it becomes very difficult to have an efficient system, when the number of user antennas is high and the channels are not static. The amount of transmission resources that is needed for uplink pilots may take a considerable amount of the system's capacity or even make it unimplementable. For prediction of the channel, it is typically assumed that the channel is completely static and will not change from the time it was estimated till the end of the downlink transmission. This assumption usually causes significant degradation in non-static channels.

In the described examples, it is assumed that the downlink and uplink channels are reciprocal and after calibration it is possible to compensate for the difference in the uplink-downlink and downlink-uplink channel responses.

The system consists of a preliminary training step, in which all users send uplink orthogonal pilots to the base-station. Although these pilots are orthogonal, they may be sent at a very low rate (such as one every second) and therefore do not overload the system too much. The base-station receives a multiple of N_{SOS} such transmissions of these pilots, and use them to compute the second-order statistics (covariance) of each channel.

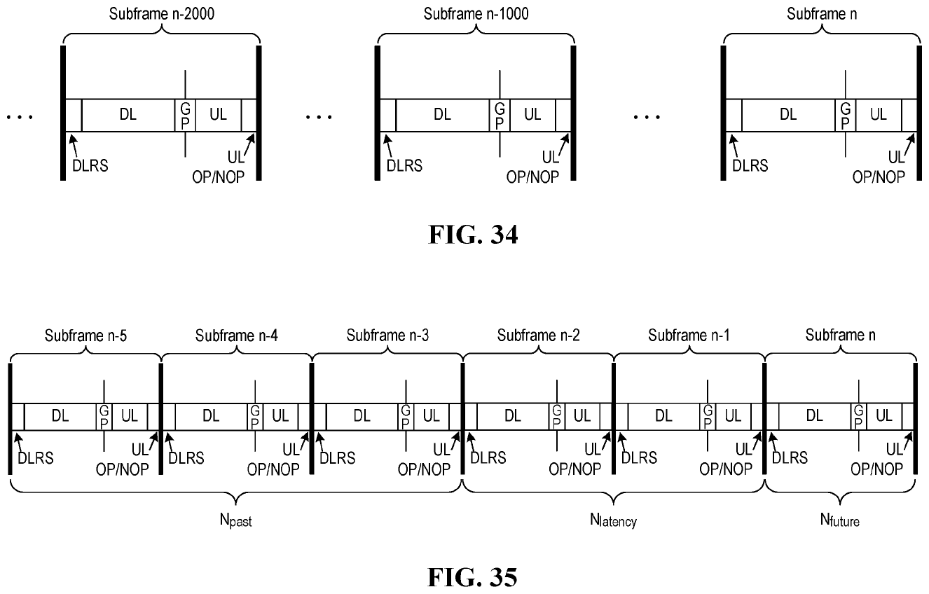

FIG. 34 shows an example of such a system, where a subframe of length 1 msec consists of a downlink portion (DL), a guard period (GP) and an uplink portion (UL). Some of the uplink portion is dedicated to orthogonal pilots (OP) and non-orthogonal pilots (NOP). Each specific user is scheduled to send on these resources its pilots every 1000 subframes, which are equivalent to 1 sec. After the reception of N_{SOS} subframes with pilots (equivalent to N_{SOS} seconds), the base-station will compute the second-order statistics of this channel.

The computation of the second-order statistics for a user antenna u is defined as:
For each received subframe i=1,2, . . . , N_{SOS} with orthogonal pilots and for each one of the L base-station receive antennas—estimate the channel along the entire frequency band (N_{f} grid elements) from the pilots and store it as the i-th column of the matrix HM^{(u)} with dimensions (N_{f}·L)×N_{SOS}.
Compute the covariance matrix

$${R}_{H H}^{( u )} = {( {H}^{( u )} )}^{H} {H}^{( u )} ,$$

where (·)^{H} is the Hermitian operator.
For the case that the channel H^{(u)} is non-zero-mean, both the mean and the covariance matrix should be determined.

To accommodate for possible future changes in the channel response, the second-order statistics may be updated later, after the training step is completed. It may be recomputed from scratch by sending again N_{SOS} orthogonal pilots, or gradually updated. One possible method may be to remove the first column of H^{(u)} and attach a new column at the end and then re-compute the covariance matrix again.

The interval at which these orthogonal pilots need to be repeated depends on the stationarity time of the channel, e.g., the time during which the second-order statistics stay approximately constant. This time can be chosen either to be a system-determined constant, or can be adapted to the environment. In particular, users can determine through observation of downlink broadcast pilot symbols changes in the second-order statistics, and request resources for transmission of the uplink pilots when a significant change has been observed. In another embodiment, the base-station may use the frequency of retransmission requests from the users to detect changes in the channel, and restart the process of computing the second-order statistics of the channel.

To reduce the computational load, it is possible to use principal component analysis (PCA) techniques on

$${R}_{H H}^{( u )} .$$

We compute {λ^{(u)}}, the K^{(u)} most dominant eigenvalues of

$${R}_{H H}^{( u )} ,$$

arranged in a diagonal matrix

$${D}^{( u )} = diag ( {λ}_{1}^{( u )} , {λ}_{2}^{( u )} , … , {λ}_{{K}^{( u )}}^{( u )} )$$

and their corresponding eigenvectors matrix V^{(u)}. Typically, K^{(u)} will be in the order of the number of reflectors along the wireless path. The covariance matrix can then be approximated by

$${R}_{H H}^{( u )} \approx {V}^{( u )} \cdot {D}^{( u )} \cdot {( {V}^{( u )} )}^{H} .$$

Non-orthogonal pilots. The non-orthogonal pilots (NOP), P^{(u)}, for user antenna u, may be defined as a pseudo-random sequence of known symbols and of size N_{NOP}, over a set of frequency grid elements. The base-station can schedule many users to transmit their non-orthogonal pilots at the same subframe using overlapping time and frequency resources. The base-station will be able to separate these pilots and obtain a high-quality channel estimation for all the users, using the method describes below.

Define the vector Y of size (L·N_{NOP})×1, as the base-station received signal over all its antennas, at the frequency grid elements of the shared non-orthogonal pilots. Let V^{(u)} be the eigenvectors matrix V^{(u)} decimated along its first dimension (frequency-space) to the locations of the non-orthogonal pilots.

The base-station may apply a Minimum-Mean-Square-Error (MMSE) estimator to separate the pilots of every user antenna:
For every user antenna u, compute

$${R}_{Y Y}^{( u )} = [ {\tilde{V}}^{( u )} ⊙ {P}^{( u )} ] \cdot {D}^{( u )} \cdot {[ {\tilde{V}}^{( u )} ⊙ {P}^{( u )} ]}^{H}$$

$${R}_{X Y}^{( u )} = {\tilde{V}}^{( u )} \cdot {D}^{( u )} \cdot {[ {\tilde{V}}^{( u )} ⊙ {P}^{( u )} ]}^{H}$$

Herein, ⊙ is defined as the element-by-element multiplication. For a matrix A and vector B, the A⊙B operation includes replicating the vector B to match the size of the matrix A before applying the element-by-element multiplication.

If principal component analysis (PCA) is not used, the covariance matrices can be computed directly as:

$${R}_{Y Y}^{( u )} = ( {{P}^{( u )} [ {P}^{( u )} ]}^{H} ) ⊙ {R}_{H H}^{( u )}$$

$${R}_{X Y}^{( u )} = ( {1 [ {P}^{( u )} ]}^{H} ) ⊙ {R}_{H H}^{( u )}$$

For the set of user antennas shared on the same resources uϵU, compute

$${R}_{Y Y} = {\sum }_{u ∈ U} {R}_{Y Y}^{( u )}$$

and invert it. Note that it is possible to apply PCA here as well by finding the dominant eigenvalues of R_{YY} (D_{R}_{_{YY}}) and their corresponding eigenvectors matrix (V_{R}_{_{YY}}) and approximating the inverse with

$${R}_{Y Y}^{- 1} \approx {V}_{{R}_{Y Y}} \cdot {D}_{{R}_{YY}}^{- 1} \cdot {( {V}_{{R}_{Y Y}} )}^{H} .$$

For each user antenna u, compute the pilot separation filter

$${C}_{P}^{( u )} = {R}_{X Y}^{( u )} \cdot {R}_{Y Y}^{- 1}$$

For each user antenna u separate its non-orthogonal pilots by computing

$${H}_{N O P}^{( u )} = {C}_{P}^{( u )} \cdot Y$$

Note that

$${H}_{N O P}^{( u )}$$

is the channel response over the frequency grid-elements of the non-orthogonal pilots for the L base-station received antennas. It may be also interpolated along frequency to obtain the channel response over the entire bandwidth.

Prediction training. The method described in the previous section for separating non-orthogonal pilots is applied to train different users for prediction. In this step, a user sends uplink non-orthogonal pilots on consecutive subframes, which are divided to 3 different sections, as shown in the example in FIG. 35.
1. Past—the first Nₚₐₛₜ subframes. These subframes will later be used to predict future subframes.
2. Latency—the following N_{latency} subframes are used for the latency required for prediction and precoding computations.
3. Future—the last N_{future} subframes (typically one), where the channel at the downlink portion will be later predicted.

Each user, is scheduled NA_{PR} times to send uplink non-orthogonal pilots on consecutive Nₚₐₛₜ+N_{latency}+N_{future} subframes. Note that in one uplink symbol in the subframe, both orthogonal and non-orthogonal pilots may be packed together (although the number of orthogonal pilots will be significantly lower than the number of non-orthogonal pilots). The base-station applies the pilot separation filter for the non-orthogonal pilots of each user and computes H_{NOP}^{(u)}. To reduce storage and computation, the channel response may be compressed using the eigenvector matrix computed in the second-order statistics step

$${H}_{K}^{( u )} = {( {\tilde{V}}^{( u )} )}^{H} \cdot {H}_{N O P}^{( u )}$$

For subframes, which are part of the “Past” section, store

$${H}_{K}^{( u )}$$

as columns in the matrix

$${H}_{p a s t , ( i )}^{( u )} ,$$

where i=1,2, . . . , N_{PR}. Use all or part of the non-orthogonal pilots to interpolate the channel over the whole or part of the downlink portion of the “Future” subframes, compress it using \tilde{V}^{(u)} and store it as

$${H}_{future , ( i )}^{( u )} .$$

Compute the following covariance matrices:

$${R}_{p ast , ( i )}^{( u )} = {H}_{p ast , ( i )}^{( u )} \cdot {( {H}_{p ast , ( i )}^{( u )} )}^{H}$$

$${R}_{f u t ure , ( i )}^{( u )} = {H}_{f u t ure , ( i )}^{( u )} \cdot {( {H}_{f u t ure , ( i )}^{( u )} )}^{H}$$

$${R}_{future \_ past , ( i )}^{( u )} = {H}_{f u t ure , ( i )}^{( u )} \cdot {( {H}_{p ast , ( i )}^{( u )} )}^{H}$$

After all N_{PR} groups of prediction training subframes have been scheduled, compute the average covariance matrices for each user

$${R}_{p a s t}^{( u )} = \frac{1}{{N}_{P R}} {\sum }_{i = 1}^{{N}_{P R}} {R}_{p ast , ( i )}^{( u )}$$

$${R}_{f u t u r e}^{( u )} = \frac{1}{{N}_{P R}} {\sum }_{i = 1}^{{N}_{P R}} {R}_{f u t ure , ( i )}^{( u )}$$

$${R}_{future \_ past}^{( u )} = \frac{1}{{N}_{P R}} {\sum }_{i = 1}^{{N}_{P R}} {R}_{future \_ past , ( i )}^{( u )}$$

Finally, for each user compute the MMSE prediction filter

$${C}_{P R}^{( u )} = {R}_{future \_ past}^{( u )} \cdot {( {R}_{p a s t}^{( u )} )}^{- 1}$$

and its error variance for the precoder

$${R}_{E}^{( u )} = {R}_{f u t u r e}^{( u )} - {C}_{P R}^{( u )} \cdot {( {R}_{future \_ past}^{( u )} )}^{H} .$$

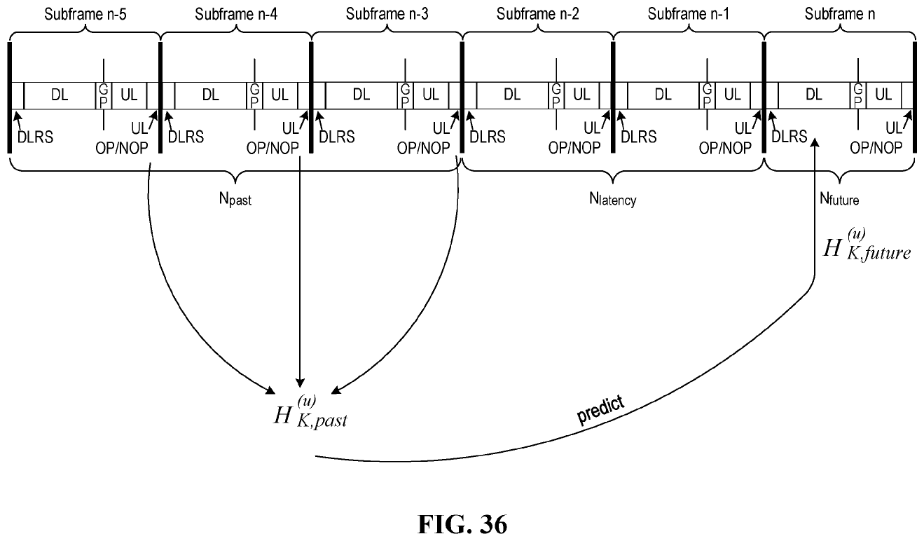

Scheduling a downlink precoded transmission. For each subframe with a precoded downlink transmission, the base-station should schedule all the users of that transmission to send uplink non-orthogonal pilots for Nₚₐₛₜ consecutive subframes, starting Nₚₐₛₜ+N_{latency} subframes before it, as shown in FIG. 36. The base-station will separate the non-orthogonal pilots of each user, compress it and store the channel response as

$${H}_{K , past}^{( u )} .$$

Then, it will apply the prediction filter to get the compressed channel response for the future part

$${H}_{K , future}^{( u )} = {C}_{P R}^{( u )} \cdot {H}_{K , p a s t}^{( u )}$$

Finally, the uncompressed channel response is computed as

$${H}_{f u t u r e}^{( u )} = {\tilde{V}}^{( u )} \cdot {H}_{K , future}^{( u )}$$

The base-station may correct for differences in the reciprocal channel by applying a phase and amplitude correction, α(f), for each frequency grid-element

$${H}_{f u ture \_ reciprocity}^{( u )} ( f ) = α ( f ) \cdot {H}_{future}^{( u )} ( f )$$

Then, use

$${H}_{future \_ reciprocity}^{( u )} and {R}_{E}^{( u )}$$

of the participating users to compute the precoder for the downlink transmission.

### 14 Examples of Second-Order Statistics for Channel Estimation

Embodiments of the disclosed technology are further directed to using second order statistics of a wireless channel to achieve efficient channel estimation. Channel knowledge is a critical component in wireless communication, whether it is for a receiver to equalize and decode the received signal, or for a multi-antenna transmitter to generate a more efficient precoded transmission.

Channel knowledge is typically acquired by transmitting known reference signals (pilots) and interpolating them at the receiver over the entire bandwidth and time of interest. Typically, the density of the pilots depends on characteristics of the channel. Higher delay spreads require more dense pilots along frequency and higher Doppler spreads require more dense pilots along time. However, the pilots are typically required to cover the entire bandwidth of interest and, in some cases, also the entire time interval of interest.

Embodiments of the disclosed technology include a method based on the computation of the second-order statistics of the channel, where after a training phase, the channel can be estimated over a large bandwidth from reference signals in a much smaller bandwidth. Even more, the channel can also be predicted over a future time interval.

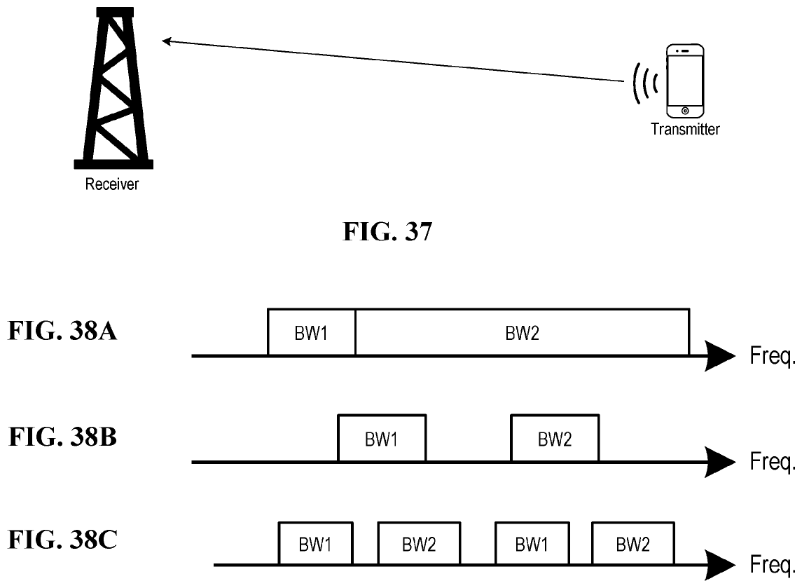

Second-order statistics training for channel estimation. FIG. 37 shows a typical setup of a transmitter and a receiver. Each one may have multiple antennas, but for simplicity we will only describe the method for a single antenna to a single antenna link. This could be easily extended to any number of antennas in both receiver and transmitter.

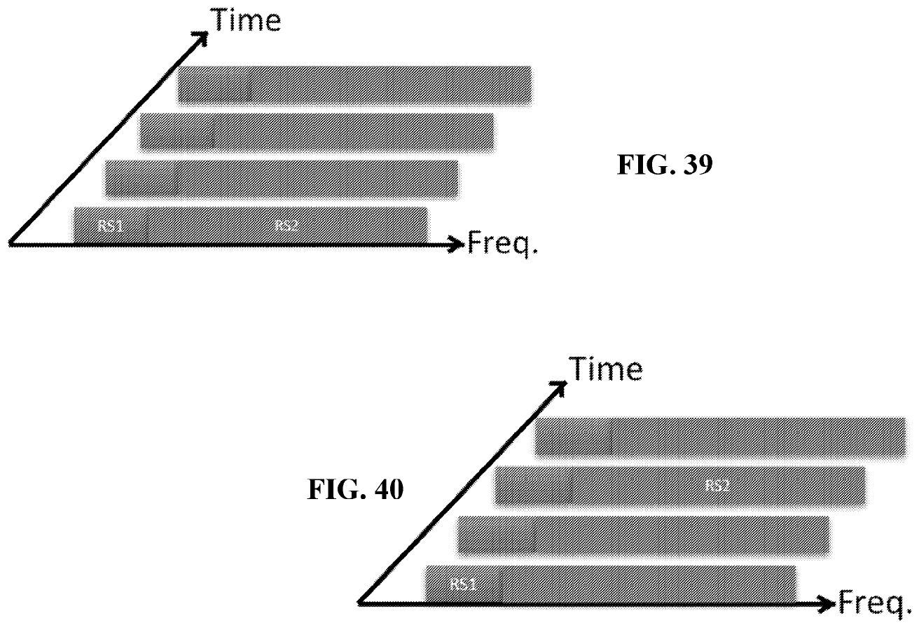

The system preforms a preliminary training phase, consisting of multiple sessions, where in each session i=1,2, . . . , N_{training}, the following steps are taken:
The transmitter sends reference signals to the receiver. We partition the entire bandwidth of interest into two parts BW₁ and BW₂, as shown in FIGS. 38A-38C, where typically the size of BW₁ will be smaller or equal to BW₂. Note, that these two parts do not have to from a continuous bandwidth. The transmitter may send reference signals at both parts at the same time interval (e.g., FIG. 39) or at different time intervals (e.g., FIG. 40).

The receiver receives the reference signals and estimates the channel over their associated bandwidth, resulting in channel responses

$${H}_{1}^{( i )} and {H}_{2}^{( i )} .$$

The receiver computes the second-order statistics of these two parts:

$${R}_{1}^{( i )} = {H}_{1}^{( i )} \cdot {( {H}_{1}^{( i )} )}^{H}$$

$${R}_{2 , 1}^{( i )} = {H}_{2}^{( i )} \cdot {( {H}_{1}^{( i )} )}^{H}$$

$${R}_{2}^{( i )} = {H}_{2}^{( i )} \cdot {( {H}_{2}^{( i )} )}^{H}$$

Herein, (·)^{H} is the Hermitian operator. For the case that the channel has non-zero-mean, both the mean and the covariance matrix should be determined. When the training sessions are completed, the base-station is configured to average out the second-order statistics.

Efficient channel estimation. After the training phase is completed, the transmitter may only send reference signals corresponding to BW₁. The receiver, estimated the channel response H₁ and use it to compute (and predict) and channel response H_{z} over BW₂ using the prediction filter:

$${H}_{2} = {C}_{p r e d i c t i o n} \cdot {H}_{1} .$$

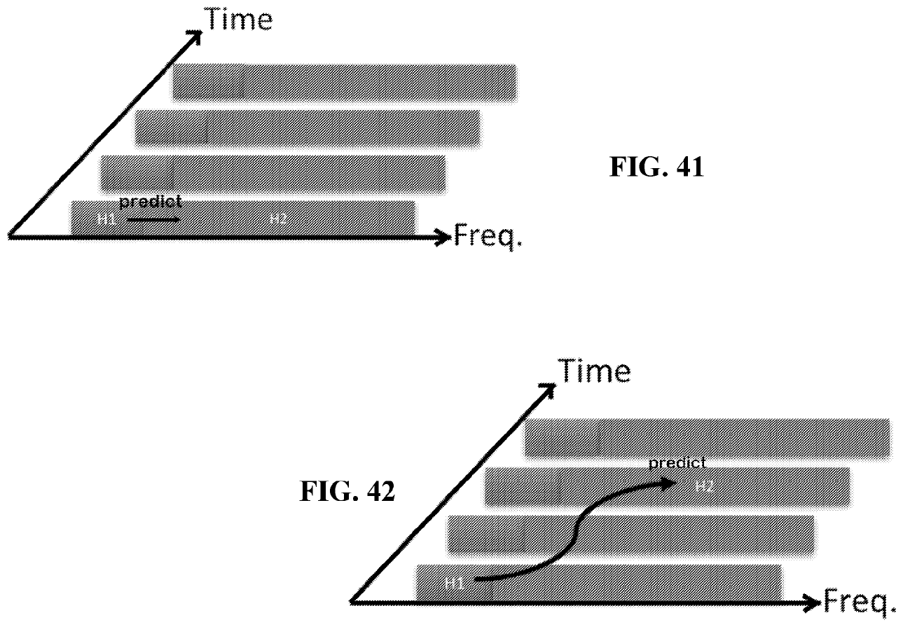

FIGS. 41 and 42 show examples of prediction scenarios (same time interval and future time interval, respectively).

### 15 Example Embodiments and Implementations of the Disclosed Technology

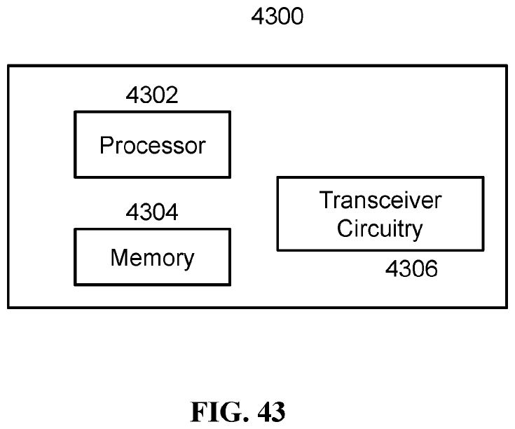

FIG. 43 is a block diagram representation of a wireless hardware platform 4300 which may be used to implement the various methods described in the present document. The hardware platform 4300 may be incorporated within a base station or a user device. The hardware platform 4300 includes a processor 4302, a memory 4304 and a transceiver circuitry 4306. The processor may execute instructions, e. g., by reading from the memory 4304, and control the operation of the transceiver circuitry 4306 and the hardware platform 4300 to perform the methods described herein. In some embodiments, the memory 4304 and/or the transceiver circuitry 4306 may be partially or completely contained within the processor 4302 (e.g., same semiconductor package).

The following examples highlight some embodiments and/or technical solutions that use one or more of the techniques described herein.

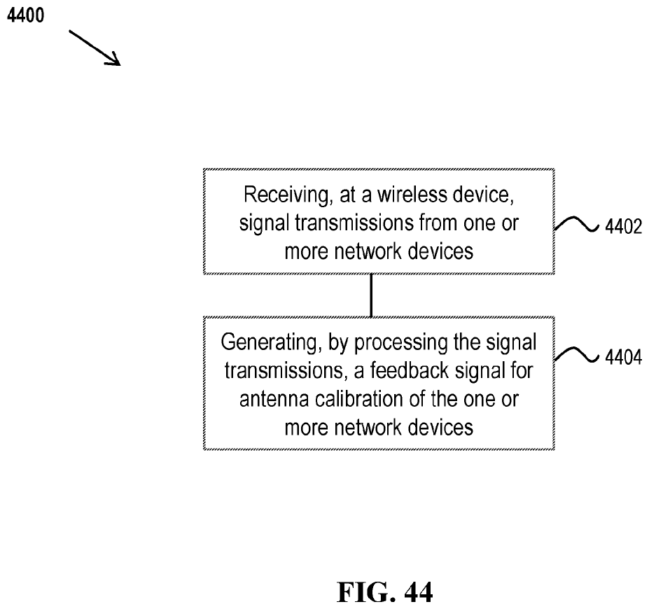

The following technical solutions may be used for UE side antenna calibration.
A1. A method of wireless communication (e.g., method 4400 depicted in FIG. 44), comprising: receiving (4402), at a wireless device, signal transmissions from one or more network devices; and generating, by processing (4404) the signal transmissions, a feedback signal for antenna calibration of the one or more network devices.
A2. The system of solution A1, further including: receiving a schedule from one of the one or more network devices, wherein the schedule is determined based on the feedback signal; and performing a communication according to the schedule.
A3. The method of solution A1 or A2, wherein the feedback signal includes a power estimate, a channel quality estimate, a phase estimate or a rank estimate.

The following technical solutions may be used for network-side antenna calibration.
A4. A method of wireless communications, comprising: transmitting one or more transmissions from one or more network devices to one or more wireless devices in a coverage area; receiving (4404) feedback reports from the one or more network devices based on the one or more transmissions; determining geographic locations of the one or more wireless device based on the feedback reports; and performing antenna calibration to adjust an antenna angle bias for the one or more network devices.
A5. The method of solution A4, further including: associating, with each wireless device, a corresponding channel quality estimate based on the feedback report.
A6. The method of solution A4 or A5, including: generating a feature map for the coverage area by associating, with the geographic locations, corresponding one or more channel quality parameters based on measurements performed on the feedback reports.
A7. The method of any of solutions A4 to A6, including: using the feature map for grouping wireless devices according to similarities in the one or more channel quality parameters; and scheduling transmissions in the coverage area according to the grouping.

In the above solutions, a frequency diverse reference signal may be used to achieve robust antenna calibration. The frequency diverse reference signal may be designed to cover all frequencies of a frequency band on a subcarrier basis such that over a period of time the entire band is covered.

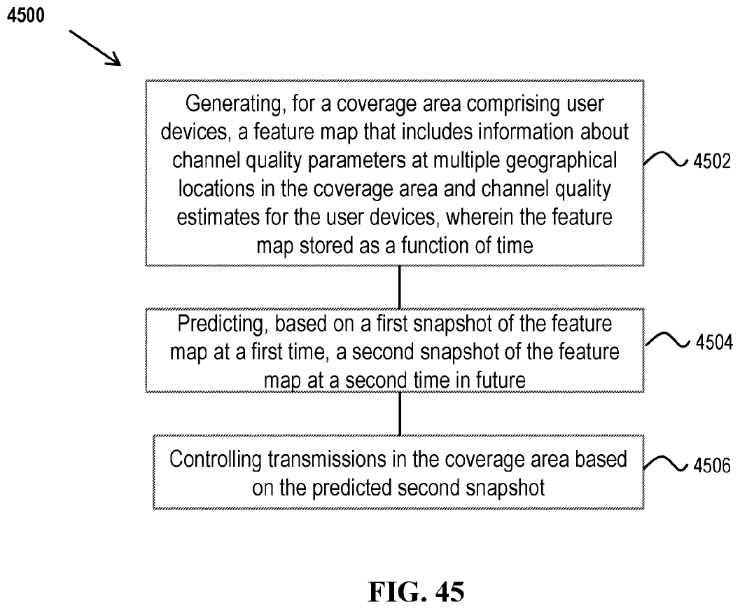

The following technical solutions may be implemented by a network device for localization and feature mapping.
A8. A method of wireless communication (e.g., method 4500 depicted in FIG. 45), comprising: generating (4502), for a coverage area comprising user devices, a feature map that includes information about channel quality parameters at multiple geographical locations in the coverage area and channel quality estimates for the user devices, wherein the feature map stored as a function of time; predicting (4504), based on a first snapshot of the feature map at a first time, a second snapshot of the feature map at a second time in future; and controlling (4506) transmissions in the coverage area based on the predicted second snapshot.
A9. The method of solution A8, wherein the coverage area is served by at least three base stations and wherein the multiple geographical locations are determined using a triangulation process based on signals received from or at the at least three base stations.
A10. The method of solution A8 or A9, wherein the first snapshot is generated based on measurements in a first frequency band and the second snapshot of the feature map is in a second frequency band different from the first frequency band.

The prediction of the second snapshot may be performed, at a different times or frequencies, using a channel prediction technique such as described in Sections 13 and 14.

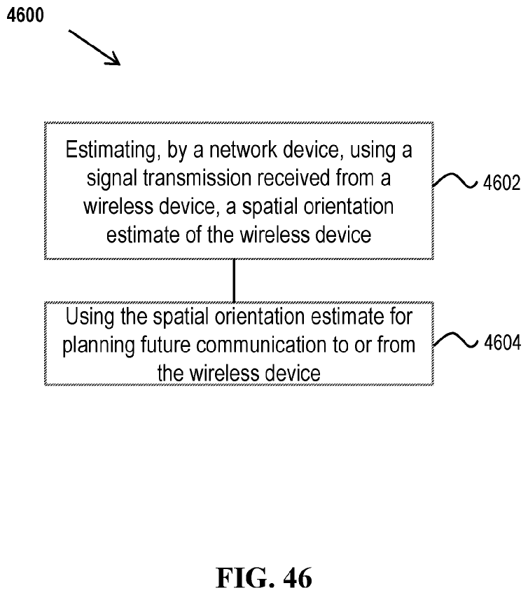

The following technical solutions may be implemented by a network device for estimating pose of a user device.
A11. A method of wireless communication (e.g., method 4600 depicted in FIG. 46), comprising: estimating (4602), by a network device, using a signal transmission received from a wireless device, a spatial orientation estimate of the wireless device; and using (4604) the spatial orientation estimate for planning future communication to or from the wireless device.
A12. The method of solution A11, further including: determining a device trajectory for the wireless device based on multiple spatial orientation estimates estimated at multiple time instances in a time period.
A13. The method of solution A12, further including: making the device trajectory available to external devices via an application programmer's interface.
A14. The method of any of solutions A11 to A13, wherein the planning the future communication includes determining a group that the wireless device belongs to or a rank used for communication to or from the wireless device or a precoding scheme used for transmissions to or from the wireless device.
A15. A wireless communication apparatus comprising a processor and a transceiver, wherein the processor is configured to perform a method recited in any one or more of solutions A1 to A14.
A16. A system comprising a plurality of wireless communication apparatus, each apparatus comprising one or more processors, configured to implement a method recited in any one or more of solutions A1 to A14.

Embodiments of the described technology provide the following technical solutions:
B1. A method of wireless communication, comprising: performing, by a network device, gain, phase and timing imbalance calibrations of multiple wireless devices in a wireless network; estimating, by the network device, angles of arrivals of the multiple wireless devices; determining wireless device grouping based on geometric properties including angels of arrivals of the multiple wireless devices; scheduling data collection from the multiple wireless devices based on the geometric properties; and simultaneously scheduling, based on communication needs, groups of wireless devices from the multiple wireless devices for data transmission or reception based on the grouping.
B2. The method of claim B1, further including: storing, in a database, historical data about previous angles of arrival measurements and groupings in the wireless network.
B3. The method of any of claims B1 to B2, wherein the gain, phase and timing imbalance calibrations are performed using transmissions comprising random access transmissions, reference signal transmissions or data transmissions.
B4. The method of any of claims B1 to B3, wherein the gain, phase and timing imbalance calibrations are performed using the angles of arrival of the multiple wireless devices.
B5. The method of any of claims B1 to B4, wherein the determining wireless device grouping comprises determining the grouping according to a rule that depends on differences in angles of arrival of wireless devices such that two devices having angles of arrivals less than a pre-determined thresholds are precluded from inclusion in a same group.
B6. The method of any of claims B1 to B5, wherein the estimating the angles of arrivals comprises estimating an angle of arrival of a particular wireless device based on a combination of one or more of (a) a feedback signal received from the particular wireless device in response to a transmission to the particular wireless device, (b) a reference signal transmission received from the particular wireless device, or (3) location estimates for the particular wireless device received from neighboring network devices.
B7. The method of any of claims B1 to B6, wherein the geometric properties include one or more of absolute locations of the multiple wireless devices, relative locations of the multiple wireless devices, or antenna orientations of the multiple wireless devices.
B8. A method of wireless communication, comprising: determining, by a first network device, a geometric property of a wireless device; communicating, by the first network device, the geometric property of the wireless device to a second network device selected based on the geometric property; and providing wireless connectivity to the wireless device in coordination with the second network device.
B9. The method of claim B8, wherein the geometric property comprises one or more of an absolute location of the wireless device, a relative location of the wireless device or orientation of multiple antennas of the wireless device.
B10. The method of claim B9, wherein the relative location of the wireless device comprises an angle or arrival between the first network device and the wireless device.
B111. The method of any of claims B8 to B10, wherein the communication is performed responsive to a query from the second network device.
B12. The method of any of claims B8 to B11, wherein the providing wireless connectivity comprises scheduling transmissions to and from the wireless device.
B13. The method of any of claims B8 to B111, wherein the providing wireless connectivity comprises coordinating with the second network device that schedules transmissions to and from the wireless device.
B14. The method of any of claims B8 to B13, wherein the second network device is selected along an angular direction towards that of the wireless device as determined by the geometric property.
B15. A wireless communication apparatus comprising a processor and a transceiver, wherein the processor is configured to perform a method recited in any one or more of above solutions.
B16. A system comprising a plurality of wireless communication apparatus, each apparatus comprising one or more processors, configured to implement a method recited in any one or more of above solutions.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1-7. (canceled)

8. A method of wireless communication, comprising:
determining, by a first network device, a geometric property of a wireless device;
communicating, by the first network device, the geometric property of the wireless device to a second network device selected based on the geometric property, wherein the geometric property comprises one or more of an absolute location of the wireless device, a relative location of the wireless device or orientation of multiple antennas of the wireless device; and
providing wireless connectivity to the wireless device in coordination with the second network device.

9. (canceled)

10. The method of claim 8, wherein the relative location of the wireless device comprises an angle of arrival between the first network device and the wireless device.

11. The method of claim 8, wherein the communicating is performed responsive to a query from the second network device.

12. The method of claim 8, wherein the providing the wireless connectivity comprises scheduling transmissions to and from the wireless device.

13. The method of claim 8, wherein the providing the wireless connectivity comprises coordinating with the second network device that schedules transmissions to and from the wireless device.

14. The method of claim 8, wherein the second network device is selected along an angular direction towards that of the wireless device as determined by the geometric property.

15. (canceled)

16. A system comprising a plurality of wireless communication apparatus, each apparatus comprising one or more processors, configured to implement a method, comprising:
performing gain, phase, and timing imbalance calibrations of multiple wireless devices;
estimating, using signals received for the calibrations, angles of arrivals of the multiple wireless devices;
determining a wireless device grouping based on geometric properties including the angles of arrivals of the multiple wireless devices;
scheduling data collection from the multiple wireless devices based on the geometric properties; and
simultaneously scheduling, based on communication needs, groups of wireless devices from the multiple wireless devices for data transmission or reception based on the wireless device grouping.

17. The system of claim 16, wherein the method further includes:
storing, in a database, historical data about previous angles of arrival measurements and groupings in the system.

18. The system of claim 16, wherein the gain, phase, and timing imbalance calibrations are performed using transmissions comprising random access transmissions, reference signal transmissions, or data transmissions.

19. The system of claim 16, wherein the gain, phase, and timing imbalance calibrations are performed using the angles of arrival of the multiple wireless devices.

20. The system of claim 16, wherein the determining the wireless device grouping is based on a rule that depends on differences in angles of arrival of wireless devices such that two devices having angles of arrivals less than a pre-determined threshold are precluded from inclusion in a same group.

21. The system of claim 16, wherein the estimating the angles of arrivals comprises estimating an angle of arrival of a particular wireless device based on a combination of one or more of (a) a feedback signal received from the particular wireless device in response to a transmission to the particular wireless device, (b) a reference signal transmission received from the particular wireless device, or (3) a location estimate for the particular wireless device received from neighboring network devices.

22. The system of claim 16, wherein the geometric properties include one or more of absolute locations of the multiple wireless devices, relative locations of the multiple wireless devices, or antenna orientations of the multiple wireless devices.

23. A first network device comprising at least one processor configured to cause the first network device to implement a method, comprising:
determining, by the first network device, a geometric property of a wireless device;
communicating, by the first network device, the geometric property of the wireless device to a second network device selected based on the geometric property, wherein the geometric property comprises one or more of an absolute location of the wireless device, a relative location of the wireless device or orientation of multiple antennas of the wireless device; and
providing wireless connectivity to the wireless device in coordination with the second network device.

24. The first network device of claim 23, wherein the relative location of the wireless device comprises an angle of arrival between the first network device and the wireless device.

25. The first network device of claim 23, wherein the communicating is performed responsive to a query from the second network device.

26. The first network device of claim 23, wherein the providing the wireless connectivity comprises scheduling transmissions to and from the wireless device.

27. The first network device of claim 23, wherein the providing the wireless connectivity comprises coordinating with the second network device that schedules transmissions to and from the wireless device.

28. The first network device of claim 23, wherein the second network device is selected along an angular direction towards that of the wireless device as determined by the geometric property.
